(19) United States
(12) Patent Application Publication
(10) Pub. No.: US 2026/0092798 A1
(43) Pub. Date: Apr. 2, 2026

(54) METHOD AND DEVICE FOR DETERMINING FLOW OF A FLUID

(71) Applicant: BELIMO HOLDING AG, Hinwil (CH)

(72) Inventor: Philip HOLOCH, Neschwil (CH)

(73) Assignee: BELIMO HOLDING AG, Hinwil (CH)

(21) Appl. No.: 19/108,970

(22) PCT Filed: Sep. 6, 2023
(86) PCT No.: PCT/EP2023/074496

§ 371 Date: Mar. 5, 2025

(30) Foreign Application Priority Data
Sep. 6, 2022 (CH) CH001035/2022

(51) Int. Cl. G01F 1/66; G01N 11/04

(52) U.S. Cl. CPC G01F 1/662; G01N 11/04

(57) ABSTRACT

A method and device for determining the flow of a fluid in a channel includes receiving, in a processing unit of a flowmeter, measurement data of the fluid, the measurement data measured by a sensor system and including a measured flow velocity of the fluid, a measured temperature of the fluid, and a measured speed of sound in the fluid, determining, in the processing unit, a viscosity of the fluid, using the measurement data and a defined relation between speed of sound, viscosity, and temperature in the fluid, and calculating, in the processing unit, a corrected flow velocity of the fluid, using the measured flow velocity and the determined viscosity.

### CROSS REFERENCE TO RELATED APPLICATIONS

This application is a National Stage of International Application No. PCT/EP2023/074496 filed Sep. 6, 2023, claiming priority based on Switzerland Patent Application No. CH001035/2022 filed Sep. 6, 2022, the contents of each of which being herein incorporated by reference in their entireties.

### FIELD OF THE DISCLOSURE

The present disclosure relates to a method and device for determining the flow of a fluid in a channel.

### BACKGROUND OF THE DISCLOSURE

To improve the efficiency of heating, ventilation, and air-conditioning (HVAC) systems, it is necessary to accurately monitor and regulate the flow of fluids. Of particular significance for HVAC systems is the monitoring of mixtures of water and an anti-freeze (e.g. Glycol).

Other areas of application where accurately monitoring and regulating the flow of fluids is important is, for example, in data centers, where servers and other electronic hardware are cooled using fluids. Immersion cooling is one manner in which electronic hardware is cooled by direct contact with a fluid. These fluids must be non-conductive and are typically pure (i.e. unmixed fluids comprising a fluid of a single type).

While various physical measurement principles may be used to measure the flow velocity of the fluid, ultrasonic flowmeters have become popular because they have no moving parts, particularly inside the fluid channel, and offer robust and repeatable measurement results. These ultrasonic flowmeters use two ultrasonic transducers to measure transit times of ultrasonic waves along one or more measurement paths in a downstream and an upstream direction. The measurement paths can be diagonally through the fluid channel, or in a U-shape, V-shape or W-shape or a helix path, using acoustic reflectors arranged in the fluid channel or by being reflected from channel walls. The flow velocity of the fluid v_{f} is related to the transit times by the following equation:

$${v}_{f} \sim \frac{1}{t 1} - \frac{1}{t 2} ,$$

where t1 is the transit time in the downstream direction and t2 is the transit time in the upstream direction. The precise average flow velocity v_{f} in the channel is further dependent on a length L of the measurement path, the geometry of the measurement path with respect to the flow direction, and further effects relating to the flow (e.g., flow profile, side-effects). The volumetric flow \dot{V} can then be calculated as a product of the flow velocity v_{f} and the cross-sectional area A of the flow space or tube.

In addition to the flow velocity of the fluid v_{f}, ultrasonic flowmeters can further measure the speed of sound vs. The speed of sound vₛ is related to the transit times by the following equation:

$${v}_{f} \sim \frac{1}{t 1} - \frac{1}{t 2} ,$$

where the precise value for the speed of sound vₛ also depends on the length L of the measurement path, the geometry of the measurement path with respect to the flow direction, and further effects relating to the flow (e.g., flow profile, side-effects).

Further, ultrasonic flowmeters are known which additionally have a temperature sensor configured to measure a temperature T of the fluid. These ultrasonic flowmeters are able to determine a concentration of glycol in the fluid by using the measured speed of sound Vs, the measured temperature T, and a defined relationship (implemented, for example, by a reference table) between speed of sound, temperature, and glycol concentration.

Further, ultrasonic flowmeters are known which measure a heat flow \dot{Q} emanating from a heat transporting fluid when passing through a consumer (e.g., a radiator). These flowmeters (also called energy meters) require an additional temperature sensor arranged on the opposite side of the consumer to the flowmeter, such that a temperature difference or differential temperature, which is the result of heat flow, can be determined. According to basic physical principles, the heat flow can be determined using the following equation:

$$\dot{Q} = ρ \cdot {c}_{p} \cdot \dot{V} \cdot ( {T}_{1} - {T}_{2} ) = ρ \cdot {c}_{p} \frac{dV}{dt} Δ T$$

Where ρ is the density of the fluid, cₚ the specific heat capacity, \dot{V} the volumetric flow of the fluid, and ΔT the temperature difference across the consumer device.

It is to be noted that the density ρ and the heat capacity cₚ of the fluid, especially a mixture of water and an antifreeze fluid like glycol, depend not only on the absolute temperature, but also on the mixing ratio.

The accuracy of determining the concentration of glycol in the fluid is dependent not only on the accuracy of the speed of sound measurement and the temperature measurement, but also on the accuracy of the reference table. Typically, the reference table is established in a laboratory by preparing mixtures of water and glycol of known mixing ratios and measuring the speed of sound at varying temperatures. However, creating mixtures with exactly known concentrations is very complicated because the antifreeze liquids are often hydrophile and contaminations during the production process or transport cannot be avoided. Regardless of the method of concentration measurement used (i.e. using a titration method which relies on a reference fluid, or using an indirect measurement via measuring refractive index), the resulting concentration has an uncertainty of approximately 2%.

### SUMMARY OF THE DISCLOSURE

It is an object of the invention and embodiments disclosed herein to provide a method and device for determining the flow of a fluid in a channel.

In particular it is an object of the invention and embodiments disclosed herein to provide a method and device for determining a flow of a fluid in a channel which does not have at least some of the disadvantages of the prior art.

The present disclosure relates to a method for determining the flow of a fluid in a channel. In particular, the fluid is a mixture of at least two different fluids, for example water and an antifreeze. The method comprises receiving, in a processing unit, measurement data of the fluid, the measurement data comprising a measured flow velocity of the fluid, a measured temperature of the fluid, and a measured speed of sound in the fluid. The method comprises determining, in the processing unit, a viscosity of the fluid, using the measurement data and a defined relation between speed of sound, viscosity, and temperature in the fluid. The method comprises calculating, in the processing unit, a corrected flow velocity of the fluid, using the measured flow velocity and the determined viscosity.

In an embodiment, the method comprises calculating the corrected flow velocity further using a defined correction relation, wherein the defined correction relation depends on the determined viscosity.

In an embodiment, the method comprises calculating the Reynolds number of the fluid using the viscosity, and the defined correction relation further depends on the Reynolds number of the fluid.

In an embodiment, the method comprises calculating the corrected flow velocity of the fluid further using a flow measurement correction factor that depends on characteristics of how the flow velocity of the fluid is measured.

In an embodiment, the method further comprises calculating, in the processing unit, a volumetric flow of the fluid, using the corrected flow velocity of the fluid and a crossectional area of the channel.

In an embodiment, the method further comprises determining, in the processing unit, a density of the fluid, using the measurement data and a defined relation between speed of sound, density, and temperature in the fluid. The method comprises calculating, in the processing unit, a mass flow of the fluid, using the volumetric flow of the fluid and the determined density of the fluid.

In an embodiment, the measurement data further comprises an acoustic impedance in the fluid, the method further comprising determining, in the processing unit, a density of the fluid, using the measurement data and a defined relation between speed of sound, density, and acoustic impedance in the fluid. The method further comprises calculating, in the processing unit, a mass flow of the fluid, using the volumetric flow of the fluid and the determined density of the fluid.

In an embodiment, the method further comprises determining, in the processing unit, a specific heat capacity of the fluid, using the measurement data and a defined relation between speed of sound, specific heat capacity, and temperature in the fluid. The method further comprises calculating, in the processing unit, an energy flow of the fluid, using the mass flow and the determined specific heat capacity.

In an embodiment, the fluid is a mixture of at least two different fluids including an antifreeze and the method further comprises determining, in the processing unit, an antifreeze concentration in the fluid using the measurement data, the determined viscosity, and a defined relation between viscosity, temperature, and antifreeze concentration in the fluid. Additionally or alternatively, the method further comprises determining, in the processing unit, the antifreeze concentration in the fluid using the measurement data, the determined density, and a defined relation between density, temperature, and antifreeze concentration in the fluid. Additionally or alternatively, the method further comprises determining, in the processing unit, the antifreeze concentration in the fluid using the measurement data, the determined specific heat capacity, and a defined relation between specific heat capacity, temperature, and antifreeze concentration in the fluid.

In an embodiment, the method comprises calculating, in the processing unit, using the antifreeze concentrations determined using at least the viscosity, the density, and/or the specific heat capacity as described herein, one or more differences in the determined antifreeze concentrations. The method further comprises detecting, in the processing unit, a change in the fluid characteristics, in particular a change in the type of antifreeze in the fluid, if one of the one or more differences in the determined antifreeze concentrations exceed a defined difference threshold.

In an embodiment, the method further comprises determining, in the processing unit, a freezing point of the fluid, using the antifreeze concentration and a defined relation between antifreeze concentration and freezing point.

In an embodiment, the method further comprises determining, in the processing unit, a freezing point of the fluid, using the measurement data and a defined relation between speed of sound, freezing point, and temperature in the fluid.

In an embodiment, the measurement data includes a second measured temperature of the fluid measured at a position different from the first measured temperature, and the method further comprises determining, in the processing unit, the heat flow emanating from the fluid, using the density, the specific heat capacity, the volumetric flow, and a temperature difference between the first temperature measurement and the second temperature measurement.

In an embodiment, the method further comprises determining, in the processing unit, an average measured temperature using the first measured temperature and the second measured temperature. The method comprises determining, in the processing unit, an average specific heat capacity using the measured speed of sound, the average measured temperature, and the defined relation between speed of sound, specific heat capacity, and temperature in the fluid. The method comprises determining, in the processing unit, the heat flow using the density, the average specific heat capacity, the volumetric flow, and a temperature difference between the first temperature measurement and the second temperature measurement.

In addition to a method for determining the flow of a fluid in a channel, the present disclosure also relates to a method for determining an energy flow of a fluid in a channel. In particular, the fluid is a mixture of at least two different fluids. The method comprises receiving, in a processing unit, measurement data of the fluid, the measurement data comprising a measured flow velocity of the fluid, a first measured temperature of the fluid, and a measured speed of sound in the fluid. The method comprises determining, in the processing unit, a density of the fluid, using the measurement data and a defined relation between speed of sound, density, and temperature in the fluid. The method comprises determining, in the processing unit, a specific heat capacity of the fluid, using the measurement data and a defined relation between speed of sound, specific heat capacity, and temperature in the fluid. The method comprises calculating, in the processing unit, a mass flow of the fluid, using the flow velocity of the fluid, a cross-sectional area of the channel, and the determined density of the fluid. The method comprises calculating, in the processing unit, an energy flow of the fluid, using the mass flow and the determined specific heat capacity.

In an embodiment, the measurement data includes a second measured temperature of the fluid measured at a position different from the first measured temperature, and the method further comprises determining, in the processing unit, the heat flow emanating from the fluid, using the density, the specific heat capacity, the volumetric flow, and a temperature difference between the first temperature measurement and the second temperature measurement.

In an embodiment, the method further comprises determining, in the processing unit, an average measured temperature using the first measured temperature and the second measured temperature. The method further comprises determining, in the processing unit, an average specific heat capacity using the measured speed of sound, the average measured temperature, and the defined relation between speed of sound, specific heat capacity, and temperature in the fluid. The method further comprises determining, in the processing unit, the heat flow using the density, the average specific heat capacity, the volumetric flow, and a temperature difference between the first temperature measurement and the second temperature measurement.

In an embodiment, the method further comprises retrieving, by the processing unit, past measurement data and/or a past value of a particular fluid property. The fluid property value relates to the corrected flow velocity, the volumetric flow, the mass flow, and/or the energy flow. The method comprises calculating, by the processing unit, a current value of the particular fluid property using, in addition to the measurement data, the past measurement data and/or the past value of the particular fluid property.

In an embodiment, the method further comprises receiving, in the processing unit, a defined set point. The defined set point relates to a flow set point, a volumetric flow set point, a mass flow set point, and/or energy flow set point. The method comprises generating, in the processing unit, a control signal using the defined set point and a fluid property value. The fluid property value relates to the corrected flow velocity, the volumetric flow, the mass flow, and/or the energy flow. The one or more fluid property values correspond to the one or more set points, i.e. the flow set point relates to the corrected flow velocity, the volumetric flow set point relates to the volumetric flow, the mass flow set point relates to the mass flow, and the energy flow set point relates to the energy flow.

The method comprises controlling, in the processing unit, an actuator connected to a valve using the control signal.

In addition to a method for determining the flow of a fluid and a method for determining an energy flow of a fluid, the present disclosure also relates to a device for determining the flow of a fluid in a channel, comprising a processing unit configured to perform at least one of the methods described herein.

In an embodiment, the method further comprises determining, in the processing unit, whether the fluid (more specifically, values defining the fluid or defining properties of the fluid) satisfies one or more defined thresholds, using the measurement data (i.e. temperature and speed of sound) or a value of a property of the fluid. The one or more defined thresholds are with the measurement data or the value of the property of the fluid, respectively. For example, the temperature may have one or more defined thresholds (e.g., an upper temperature threshold and/or a lower temperature threshold), with similar considerations applied to the speed of sound and the other (calculated) values of the fluid properties, the fluid properties including density, specific heat capacity, viscosity, and antifreeze concentration. The method comprises generating, in the processing unit, a notification message, if the fluid does not satisfy the one or more defined thresholds.

In an embodiment, the device further comprises a sensor system connected to the processing unit. The sensor system is configured to measure a flow velocity of the fluid, a speed of sound in the fluid, and a temperature of the fluid. The sensor system is configured to transmit measurement data to the processing unit, the measurement data including the flow velocity of the fluid, the speed of sound in the fluid, and the temperature of the fluid.

In an embodiment, the device further comprises a sensor system including an ultrasonic measurement assembly.

In an embodiment, the ultrasonic measurement assembly includes two ultrasonic transducers coupled to the channel. The ultrasonic measurement assembly is configured to measure a transit time of one or more ultrasonic pulses transmitted from a first ultrasonic transducer and received by a second ultrasonic transducer, and measure a transit time of one or more ultrasonic pulses transmitted from the second ultrasonic transducer and received by the first ultrasonic transducer. Additionally or alternatively, the ultrasonic measurement assembly is configured to measure transit times of surface acoustic waves between the ultrasonic transducers. The ultrasonic measurement assembly is configured to determine the following properties of the fluid using the transit times: a flow velocity, a speed of sound, a temperature, and/or an acoustic impedance. The ultrasonic measurement assembly is configured to transmit measurement data to the processing unit, the measurement data including the one or more determined properties of the fluid. Alternatively, the ultrasonic measurement assembly is configured to transmit the transit times to the processing unit, the processing unit being configured to determine the properties of the fluid using the transit times.

In an embodiment, the sensor system includes a first temperature sensor arranged at a first position.

In an embodiment, the sensor system includes a second temperature sensor arranged at a second position, wherein the second position is different to the first position, in particular wherein the second position is on an opposing side of a consumer device, in flow direction, with respect to the first position.

In addition to the methods and device, the present disclosure also relates to a computer program product comprising computer program code configured to control a processing unit of a device such that the device performs the steps according to one of the methods disclosed herein.

In particular, the present disclosure relates to a computer-readable medium comprising a non-transitory memory having stored thereon computer program code configured to control a processing unit of a device such that the device performs the steps according to one of the methods disclosed herein.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 shows a block diagram illustrating schematically a flow meter with an integrated controller;

FIG. 2 shows a block diagram illustrating schematically a flow meter and a separated controller;

FIG. 3 shows a diagram illustrating schematically a sensor system for measuring a flow velocity, a speed of sound, and a temperature of a fluid in a channel, in which the sensor system comprises two ultrasonic transducers arranged diagonally across from each other on opposing sides of the channel;

FIG. 4 shows a diagram illustrating schematically a sensor system for measuring a flow velocity, a speed of sound, and a temperature of a fluid in a channel, in which the sensor system comprises two ultrasonic transducers arranged next to each other on the same side of the channel and the ultrasonic pulses are reflected off one or more channel walls;

FIG. 5 shows a diagram illustrating schematically a sensor system for measuring a flow velocity, a speed of sound, and a temperature of a fluid in a channel, in which the sensor system comprises two ultrasonic transducers arranged next to each other on the same side of the channel and the ultrasonic pulses are reflected off acoustic deflectors arranged in the channel;

FIG. 6 shows a diagram illustrating schematically a sensor system for measuring a flow velocity, a speed of sound, and a temperature of a fluid in a channel, in which the sensor system comprises two ultrasonic transducers arranged next to each other on the same side of the channel and configured to measure transit times of surface acoustic waves travelling along and through the channel;

FIG. 7 shows a 3D plot illustrating a relation between viscosity, speed of sound, and temperature;

FIG. 8 shows a 3D plot illustrating a relation between specific heat capacity, speed of sound, and temperature;

FIG. 9 shows a 3D plot illustrating a relation between density, speed of sound, and temperature;

FIG. 10 shows a plot illustrating the relationship between Reynolds number and the correction factor for an exemplary ultrasonic measurement path;

FIG. 11 shows a flow diagram illustrating an exemplary sequence of steps for calculating a corrected flow velocity;

FIG. 12 shows a flow diagram illustrating an exemplary sequence of steps for calculating a volumetric flow of the fluid;

FIG. 13 shows a flow diagram illustrating an exemplary sequence of steps for calculating a mass flow of the fluid;

FIG. 14 shows a flow diagram illustrating an alternative exemplary sequence of steps for calculating a mass flow of the fluid;

FIG. 15 shows a flow diagram illustrating an exemplary sequence of steps for calculating an energy flow of the fluid; and

FIG. 16 shows a flow diagram illustrating an exemplary sequence of steps for determining an antifreeze concentration in the fluid;

FIG. 17 shows a flow diagram illustrating an exemplary sequence of steps for determining a heat flow emanating from the fluid;

FIG. 18 shows a flow diagram illustrating an exemplary sequence of steps for determining a heat flow using an average heat capacity;

FIG. 19 shows a flow diagram illustrating an exemplary sequence of steps for determining an energy flow of a fluid; and

FIG. 20 shows a flow diagram illustrating an exemplary sequence of steps for selecting and/or correcting a calculated value of a property of the fluid.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

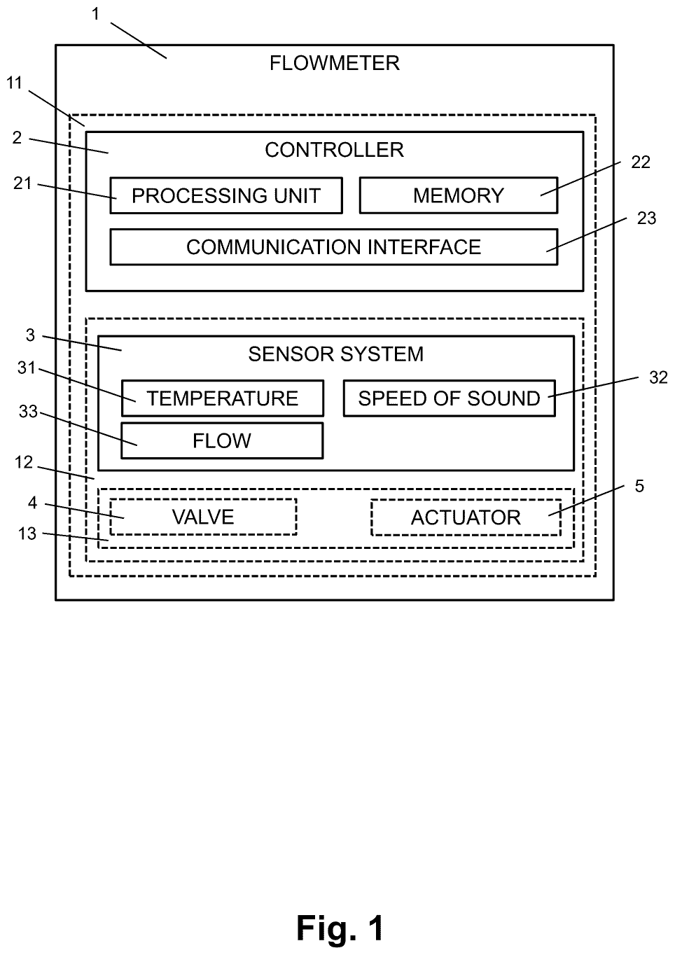

In FIG. 1, reference numeral 1 refers to a flowmeter 1, for example as adapted for measuring the flow of a fluid in a heating, ventilation, and air conditioning (HVAC) system. The flowmeter 1 comprises a controller 2 and a sensor system 3. The fluid is, depending on the embodiment, a binary fluid, more specifically a water/antifreeze mixture, or even more specifically a water/glycol mixture. In other embodiments, the fluid is unmixed, i.e. comprises a single fluid type. For example, the fluid is a non-conductive fluid used for immersion cooling of electronics.

An optional valve 4 controls the flow of the fluid through the HVAC system, in particular through a channel 6 for which the flowmeter 1 measures the flow. The channel is, for example, a duct or a pipe of the HVAC system. The valve 4 is controlled by an optional actuator 5. The actuator 5 is an electromechanical device comprising an electric motor which, depending on a control signal, alters the opening or closing of the valve 4 to allow more or less, respectively, fluid through the valve 4. The fluid is driven through the HVAC system by a pump. The fluid flows through a heater and/or a cooler, which heats or cools the fluid. The fluid also flows through a consumer device, such as a heat exchanger. The heat exchanger deposits or absorbs heat energy from the fluid into an environment around the heat exchanger.

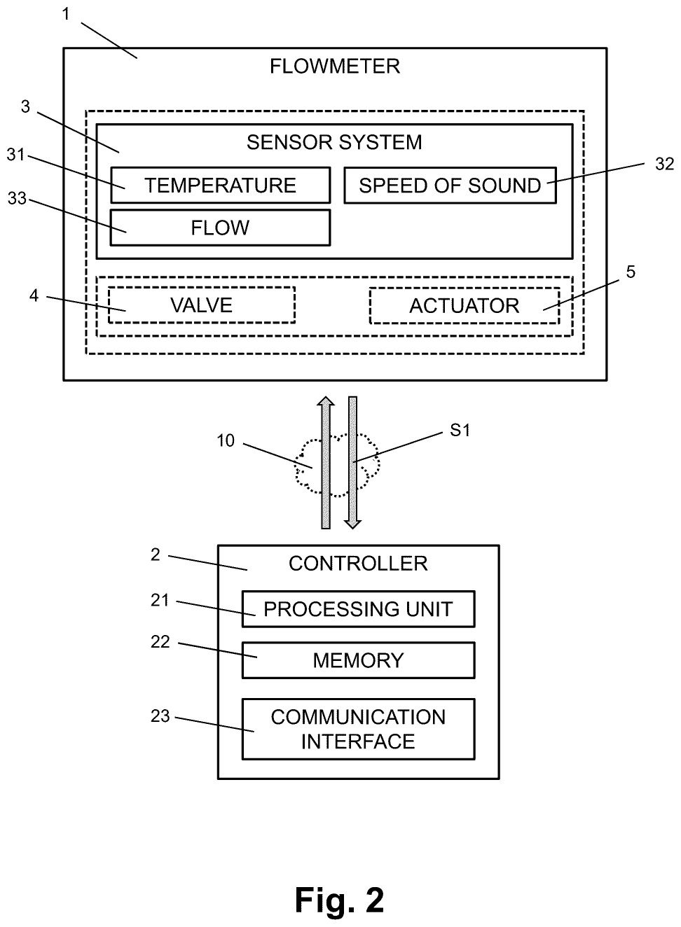

In some embodiments, one or more components of the flowmeter 1 as described above are integrated together. In another embodiment, for example as described below with reference to FIG. 2, the controller 2 and the sensor system 3 are implemented as separate devices which are communicatively coupled together.

In an embodiment, the valve 4 and the actuator 5 are arranged in a single device, as indicated by the dashed box 13.

In an embodiment, the sensor system 3, the valve 4, and the actuator 5 are arranged in a single device, as indicated by the dashed box 12.

In a preferred embodiment the controller 2 und the sensor system 3 are part of a single device.

In an embodiment, the controller 2, the sensor system 3, the valve 4, and the actuator 5 are integrated into a single device, as indicated by the dashed box 11.

In an embodiment, the sensor system 3 also comprises a processing unit (e.g., a microprocessor) and a memory (e.g., flash memory), and one or more functions and/or steps as described in the present disclosure are performed in the sensor system 3 by the processing. Further, certain data as described in the present disclosure are stored in the memory of the sensor system 3, depending on the embodiment.

The sensor system 3 comprises one or more functional and/or structural modules, parts, or components configured to determine measurement data of the fluid, more particularly to measure physical properties of the fluid. In particular, the measurement data includes: the measured temperature of the fluid, the measured speed of sound, and/or the measured flow velocity of the fluid. To that end, the sensor system 3 comprises one or more of the following modules: a temperature module 31, a speed of sound module 32, and/or a flow module 33. The aforementioned modules 31, 32, 33 are configured to measure the temperature, speed of sound, and/or the flow velocity, respectively. Depending on the embodiment, the modules are implemented as structural modules (i.e. using one or more dedicated circuits, in particular integrated circuits) or as functional modules (in particular implemented as software modules in the processing unit of the sensor system 3).

The measurement data can be measured using one or more sensors, actuators, and/or transducers which may be based on one or more types of measurement principles. Depending on the specific measurement principles used, one or more of the physical properties included in the measurement data can be determined using a particular measurement principle, as is explained below in more detail and illustrated by way of the described examples.

For example, the sensor system 3 includes a temperature sensing element 35 (not shown), such as a thermistor or resistive temperature detector (RTD), configured such that the temperature of the fluid can be measured in the temperature module 31. The temperature sensing element 35 is either in direct contact or in indirect contact with the fluid.

In another example, the sensor system 3 includes a flow sensing assembly, such as a magnetic flow assembly in which a voltage is measured that is proportional to the flow velocity of the fluid, a mechanical flow assembly which has a rotational device such as a paddle wheel or propeller which rotates in proportion to the flow velocity, as well as ultrasonic flow assembly in which ultrasonic signals are used to measure the flow velocity, as is explained below in more detail.

In an example, the sensor system 3 includes a speed of sound sensing assembly configured to measure the speed of sound using pressure transducers.

In an embodiment, the sensor system 3 comprises a first ultrasonic transducer 34A and a second ultrasonic transducer 34B (not shown), which enable a measurement of multiple physical properties of the fluid. Using the transit times of ultrasonic signal transmitted from the first ultrasonic transducer 34A and received by the second ultrasonic transducer 34B, and vice versa, the speed of sound and the flow velocity can be measured by the sensor system 3, in particular in the speed of sound module 32 and in the flow velocity module 33.

Alternatively or additionally, the ultrasonic transducers 34A, 34B and the sensor system 3 are configured to measure the transit times of surface acoustic waves (SAWs) between the ultrasonic transducers 34A, 34B. The surface acoustic waves (SAWs) travel not only through the fluid in the channel, but also along the channel wall and/or through other structural components situated between the first ultrasonic transducer 34A and the second ultrasonic transducer 34B. By measuring the transit times of surface acoustic waves (SAWs), the sensor system 3, in particular the temperature module 31, can further measure the temperature of the fluid without requiring a separate temperature sensor 35.

Depending on the embodiment, the sensor system 3 is configured to transmit the measurement data received from the one or more sensors directly to the controller 2 in one or more forms. For example, the measurement data includes “raw” sensor signals received directly from the sensors (e.g., time-varying analog or digital signals received from the ultrasonic transducers 34A, 34B and/or the temperature sensor 35). These “raw” sensor signals are then processed by the controller 2, in particular by the processing unit 21 of the controller, to determine the physical properties of the fluid (i.e. the temperature, speed of sound, and/or the flow velocity).

Additionally or alternatively, the sensor system 3 is configured to process the sensor signals received from the sensors and transmit, to the controller 2, the measurement data directly indicating the values of the physical properties.

Additionally or alternatively, the sensor system 3 is configured to process the sensor signals received from the sensors and transmit, to the controller 2, intermediate values (in particular, transmit times of ultrasonic signals) which enable the controller 2 to determine the physical properties using known relations of transit times to the speed of sound, flow velocity in the fluid, and/or the temperature.

In an embodiment, the sensor system 3 is part of a heat meter and comprises an additional temperature sensor installed a second position different from the first position, which allows the sensor system 3 to measure a temperature difference and allow the sensor system 3 and/or the controller 2 to determine the heat transferred to and/or from the environment by the consumer device. The second position is therefore on the opposite side of the consumer device to the first position. In particular, if the consumer device is downstream from the first position, then the second position is further downstream than the consumer device. Analogously, if the consumer device is upstream from the first position, then the second position is further upstream than the consumer device. The calculation of the heat transfer is performed either by the controller in the sensor system 3 itself, or in the controller 2.

The sensor system 3 is connected to the controller 2. The sensor system 3 is configured to send measurement data to the controller 2, which the controller 2 receives.

The sensor system 3 is configured to receive measurement commands from the controller 2, upon receipt of which the sensor system 3 carries out measurements and transmits measurement data to the controller 2.

In an embodiment, the sensor system 3 continuously carries out measurements at predetermined intervals. For example, the controller 2 queries the sensor system 3, and the sensor system 3, upon receiving the query, transmits measurement data to the controller 2 periodically.

The controller 2 comprises an electronic circuit including a processing unit 21 and various modules. The modules include a memory 22 and a communication interface 23, for example a BACnet and/or Modbus interface. Depending on the embodiment, the modules further include a display, a battery, and/or a user interface. The battery can also be part of the sensor system 3. The user interface can be integrated into the display in the form of a touch-sensitive display. The user interface, in an example, comprises buttons. The modules of the controller 2 are connected to each other via a data connection mechanism, such that they can transmit and/or receive data. The communication interface 23 is configured for wired and/or wireless communication with the sensor system 3. The controller 2 is also connected to one or more of: the actuator 5, the pump, or the heater and/or cooler and is configured to transmit control signals to these for controlling the operation of the flowmeter 1. Depending on the embodiment, the communication interface 23 is configured to communicate with remote servers via a communication network 10.

The communication network 10, as depicted in FIG. 2 below, comprises the Internet as well as other intermediary networks. The wireless communication takes place using a mobile data network, such as GSM, CDMA and LTE networks, and/or a close range wireless communication interface using a Wi-Fi network, Bluetooth, NFC, and/or other wireless network type and standard. In an example, the processing unit 21 provides an internal webserver which hosts a webpage, the webpage providing the user interface.

In an embodiment, the controller 2 communicates with the remote servers via a local gateway, which local gateway forwards messages from the controller 2 to the remote servers and vice versa (i.e. the local gateway also forwards messages from the remote servers to the controller 2.

The term data connection mechanism relates to a mechanism that facilitates data communication between two modules, devices, systems, or other entities. The data connection mechanism is a wired connection across a cable or system bus, or wireless connection using direct or indirect wireless transmissions.

Depending on the embodiment, the electronic circuit or the processing unit 21, respectively, comprises a system on a chip (SoC), a central processing unit (CPU), and/or other more specific processing units such as a graphical processing unit (GPU), application specific integrated circuits (ASICs), reprogrammable processing units such as field programmable gate arrays (FPGAs), as well as processing units specifically configured to accelerate certain applications, such as artificial intelligence (AI) accelerators for accelerating neural network and/or machine learning processes.

The memory 22 comprises one or more volatile (transitory) and or non-volatile (nontransitory) storage components. The storage components may be removable and/or nonremovable, and can also be integrated, in whole or in part with the controller 2. Examples of storage components include RAM (Random Access Memory), flash memory, hard disks, data memory, and/or other data stores. The memory 22 has stored thereon computer program code configured to control the processing unit 21 of the controller 2, such that the controller 2 performs one or more steps and/or functions as described herein. The memory 22 additionally stores data related the fluid, in particular the relations, functions, tables, etc. described herein.

The memory 22 may further include a data log, in particular a data log which records the measurement data and/or one or more values of the properties of the fluid which are determined using the methods described herein. The data log may include periodic entries, in particular periodic entries of the measurement data and/or the values of the properties. The periodic entries may be recorded whenever a measurement and/or a calculation is performed. The periodic entries may be recorded at defined time-intervals. The data log may further include event entries indicative and/or responsive to particular events. For example, the memory may store an event entry if the measurement data and/or one or more of the properties of the fluid do not satisfy particular defined thresholds, for example thresholds related to maximum and/or minimum permitted values, or rates of change of measurement data and/or properties exceeding defined rates of change.

Depending on the embodiment, the computer program code is compiled or non-compiled program logic and/or machine code. As such, the controller 2 is configured to perform one or more steps and/or functions. The computer program code defines and/or is part of a discrete software application. One skilled in the art will understand, that the computer program code can also be distributed across a plurality of software applications. The software application is installed in the controller 2. Alternatively, the computer program code can also be retrieved and executed by the controller 2 on demand. In an embodiment, the computer program code further provides interfaces, such as APIs (Application Programming Interfaces), such that functionality and/or data of the controller 2 can be accessed remotely, such as via a client application or via a web browser. In an embodiment, the computer program code is configured such that one or more steps and/or functions are not performed in controller 2 but in a remote server at a different location to the controller 2, e.g. in a cloud-based computer system.

FIG. 2 shows a diagram illustrating schematically an embodiment of the invention in which the controller 2 is separate from the flowmeter 1 and is connected with the flowmeter 1 using the data connection mechanism. In particular, the communication interface 23 of the controller 2 is connected with the sensor system 3 of the flowmeter 1 using the data connection mechanism. Further, in an embodiment, the sensor system 3 also has a communication interface configured for wired and/or wireless transmission.

In an embodiment, the controller 2 is connected directly to the flowmeter 1 using the data connection mechanism. In this embodiment, the controller 2 is located at or near the location of the flowmeter 1, such as in the same building or on the same premises as the flowmeter 1. In an example, the controller 2 is implemented as a mobile communication device, for example a mobile phone. The mobile phone, for example a smart-phone running the Android operating system or the iOS operating system, is configured to download and install the computer program code from a server, for example from an App store. Further examples of controllers 2 are tablet computers, smartwatches and the like. Another example of the controller 2 implemented as a mobile communication device is a portable computer, for example a laptop.

In an embodiment, in addition to being connected to the flowmeter 1, the controller 2 is also connected to the remote server via the Internet 10, using the communication interface 23. The connection to the remote server enables the controller 2 to exchange data with the remote server at the same time as exchanging data with the flowmeter 1.

In an embodiment, the controller 2 is located remotely from the flowmeter 1 and is connected to the flowmeter 1 via the Internet 10. In particular, the controller 2 is implemented on the remote server and exchanges data with the sensor unit 3 of the flowmeter 1.

Optionally, the local gateway acts as an intermediary between the controller 2 and the sensor system 3.

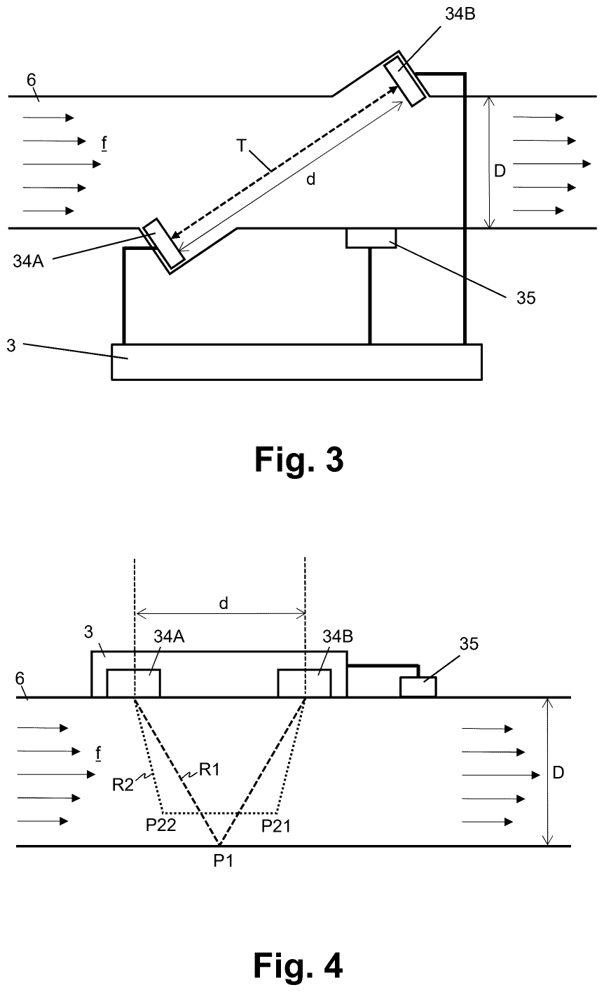

FIGS. 3 to 5 illustrate various ultrasonic measurement assemblies which are part of the sensor system 3. The ultrasonic measurement assembly is installed on a channel 6 through which a fluid flows in a flow direction f. The channel has a diameter D and is part of a flow circuit. The flow circuit includes, depending on the embodiment, one or more pumps, valves, heaters and/or coolers, and/or heat exchangers.

As illustrated by the differing lengths of the arrows indicating the flow, the fluid velocity through the channel is not the same at every point in the channel 6. In particular, due to interactions with a sidewall of the channel 6, the fluid velocity closer to the channel wall is less than the fluid velocity along a centerline of the channel 6. The precise flow velocity profile through the channel 6 depends on the geometry of the cross section of the channel, geometric particularities of the channel, whether the flow is laminar or turbulent (which may be expressed through the Reynolds number), etc. In particular, the arrows are illustrative of laminar flow. However, different scenarios are possible, in particular turbulent flow.

Each ultrasonic measurement assembly includes a first ultrasonic transducer 34A and a second ultrasonic transducer 34B configured to transmit ultrasonic pulses through the fluid (and optionally along a channel wall). The ultrasonic measurement assembly is connected (or may be considered to be part of) the sensor system 3.

The temperature sensor 35 is also installed on the sidewall of the channel 6.

In FIG. 3, the first ultrasonic transducer 34A is arranged in a recess of the channel side wall and oriented such that the ultrasonic signals emitted travel diagonally across the channel towards the second ultrasonic transducer 34B, which is arranged in a recess on the opposing side of the channel 6 and downstream from the first ultrasonic transducer 34A. The sensor system 3 is configured to measure a transit time t1 of a first ultrasonic pulse travelling from the first ultrasonic transducer 34A to the second ultrasonic transducer 34B and measuring the transit time t2 of a second ultrasonic pulse travelling from the second ultrasonic transducer 34B to the first ultrasonic transducer 34A. By using the known distance d between the ultrasonic transducers 34A, 34B and the diameter D of the channel or of the angle a line between the ultrasonic transducers 34A, 34B and a centerline of the channel 6 forms, the speed of sound and the flow velocity of the fluid in the channel 6 are measured.

FIG. 4 shows a sensor system 3 in which the first and second ultrasonic transducers 34A, 34B are arranged on the same side of the channel 6, preferably in a common housing. The first and second ultrasonic transducers 34A, 34B are configured to exchange ultrasonic pulses and measure the transit times of the ultrasonic pulses which can be reflected at least once by an internal channel wall.

In particular, the first ultrasonic transducer 34A is configured to transmit a first ultrasonic pulse into the channel 6, which can travel along a path R1, in which it reflects once on a reflection point P1 on the opposing channel side wall, and is received by the second ultrasonic transducer 34B. The sensor system 3 is configured to measure a first transit time t1a of the first ultrasonic pulse.

Depending on the particular geometry of the channel 6, the first ultrasonic pulse can also travel along further paths in which it is reflected by the channel wall two or more times. For example, when the channel 6 is a circular cylinder, the first ultrasonic pulse also travels along a path R2, in which the first ultrasonic pulse is reflected by the channel side wall twice—once at a reflection point P22 and once at a reflection point P23, before it is received in the second ultrasonic transducer 34B. The path R2 thereby has a triangular shape centered on a centerline of the cylinder. Other geometries and paths are possible, in particular depending on the geometry of the channel 6. The sensor system 3 is configured to measure a second transit time t1b of the first ultrasonic pulse.

Similarly, the second ultrasonic transducer 34B transmits a second ultrasonic pulse which is reflected once or more times in the channel 6 before being received by the first ultrasonic transducer 34A. The sensor system 3 is configured to measure a first transit time t2a of the second ultrasonic pulse, as well as a second transit time t2b of the second ultrasonic pulse.

The sensor system 3 is configured to determine the flow velocity of the fluid and the speed of sound of the fluid using at least the transit times t1a and t2a of the ultrasonic pulses, the distance d between the first and second ultrasonic transducers, and geometric characteristics of the channel 6, in particular using the diameter D of the channel and a cross-sectional shape of the channel 6. Preferably, the sensor system 3 is further configured to determine the flow velocity of the fluid and the speed of sound of the fluid further using the transit times t1b and t2b of the ultrasonic pulses.

The sensor system 3 further includes a temperature sensor 35 attached to the channel 6 at a first position. Depending on the implementation, the temperature sensor 35 can be separate to a housing comprising the ultrasonic transducers 34A, 34B, or integrated into the same housing.

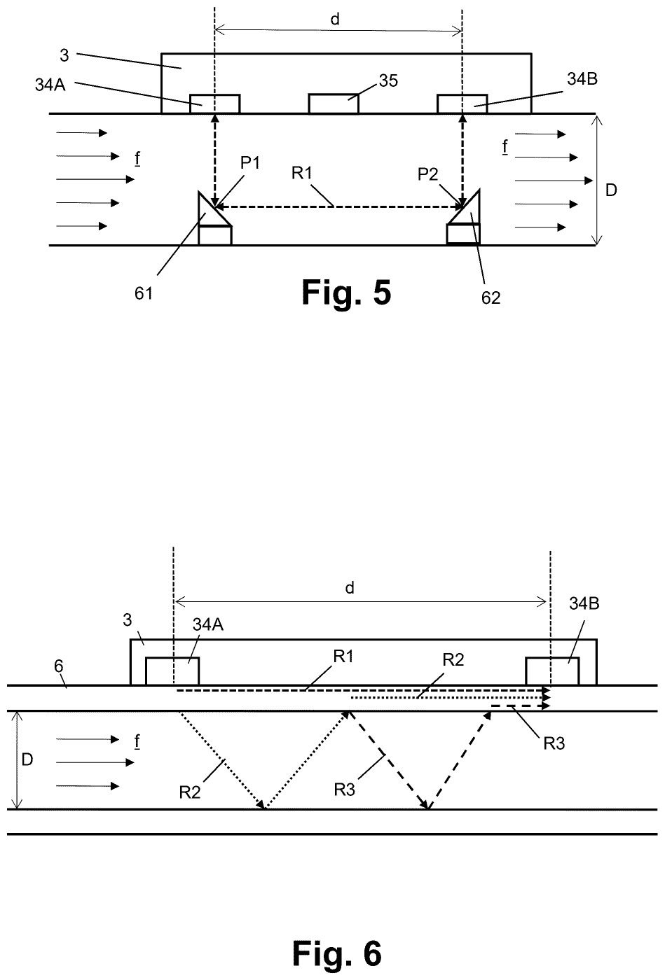

FIG. 5 shows a sensor system 3 in which the first and second ultrasonic transducers 34A, 34B are arranged in a similar manner as described with reference to FIG. 4. However, the channel 6 includes two acoustic deflectors 61, 62 arranged on an opposing side of the channel 6 to the ultrasonic transducers 34A, 34B and configured such that an ultrasonic pulse emitted by the first ultrasonic transducer 34A is reflected off the first acoustic deflector 61 at a deflection point P1, after which it travels parallel to the flow direction f until being deflected off the second acoustic deflector 62 at a deflection point P2 and is deflected towards the second ultrasonic transducer 34B. Thereby, at least part of the path R1 of the ultrasonic pulse is parallel to the flow direction, which simplifies calculations for determining the speed of sound and the flow velocity.

FIG. 6 shows the sensor system 3, for example as implemented in FIG. 4 or 5, in which the sensor system is additionally or alternatively to determining the “classic” transit times of ultrasonic pulses in the channel as described herein, configured to determine the transit times of one or more surface acoustic waves (SAWs) which travel between the first ultrasonic transducer 34A and the second ultrasonic transducer 34B. The sensor system 3 is configured to measure SAWs which travel in both directions between the ultrasonic transducers 34A, 34B, however for clarity, FIG. 6 shows only SAWs travelling from the first ultrasonic transducer 34A to the second ultrasonic transducer 34B.

The SAWs travel along multiple paths R1, R2, R3 . . . from the first ultrasonic transducer 34A to the second ultrasonic transducer 34B. A first path R1 is along the channel sidewall. The sensor system 3 is configured to determine the transit time t1 of the SAW from the first ultrasonic transducer 34A to the second ultrasonic transducer 34B and, using the distance d between the ultrasonic transducers 34A, 34B and known material properties of the channel sidewall, determine the temperature T of the channel sidewall and thereby also the temperature T of the fluid. Thereby, a separate temperature sensor 35 for measuring the temperature is not necessary.

A second path R2 occurs when the SAW couples out of the channel sidewall into the fluid at the Raleigh angle. The SAW which has coupled into the fluid reflects off the opposing channel sidewall and is reflected. The SAW can then either be coupled back into the channel sidewall and travel along the channel sidewall along path R2 to the second ultrasonic transducer 34B, or be reflected further off the channel sidewall along path R3. Path R3 thereby branches off path R2 and has a further reflection off the opposing sidewall of the channel 6 before being coupled back into the channel sidewall of the ultrasonic transducers 34A, 34B. Further paths are possible, depending on the particular configuration of the ultrasonic transducers 34A, 34B (specifically depending on the distance d between them), the channel diameter D, and the cross-sectional geometry of the channel 6.

By determining the transit times of the SAWs along the various paths R1, R2, R3, it is possible to calculate, using the transit times of ultrasonic pulses along the various paths R1, R2, R3, in addition to the temperature T as mentioned above, also the flow velocity of the fluid and the speed of sound in the fluid.

In addition, the sensor system 3 is configured to use the amplitude of the ultrasonic pulses as received in the receiving ultrasonic transducer 34A, 34B, to calculate the acoustic impedance in the fluid. It is further configured to determine the fluid density, by using the acoustic impedance, the speed of sound, and a defined relation between speed of sound, acoustic impedance, and density in the fluid.

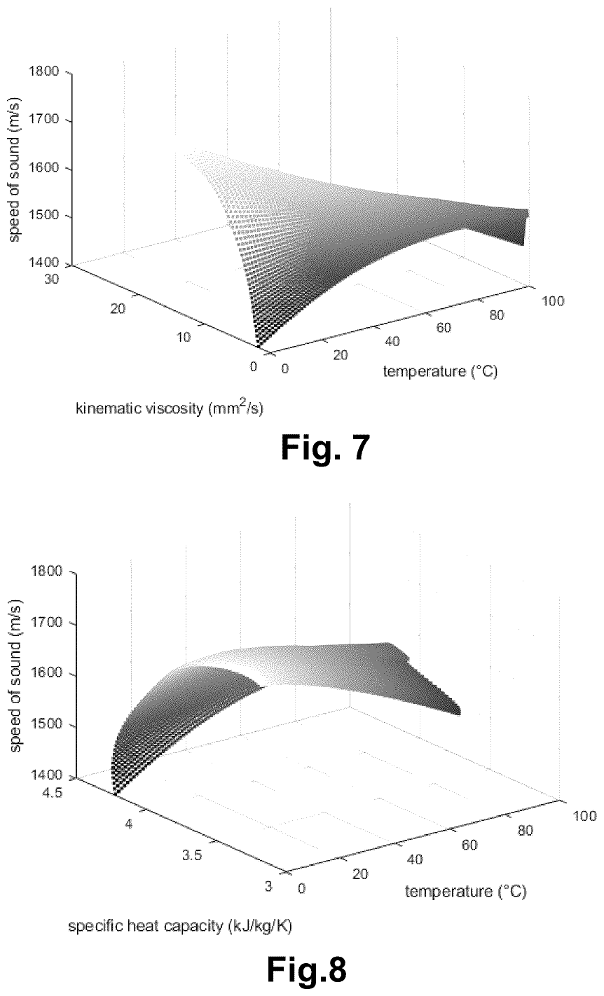

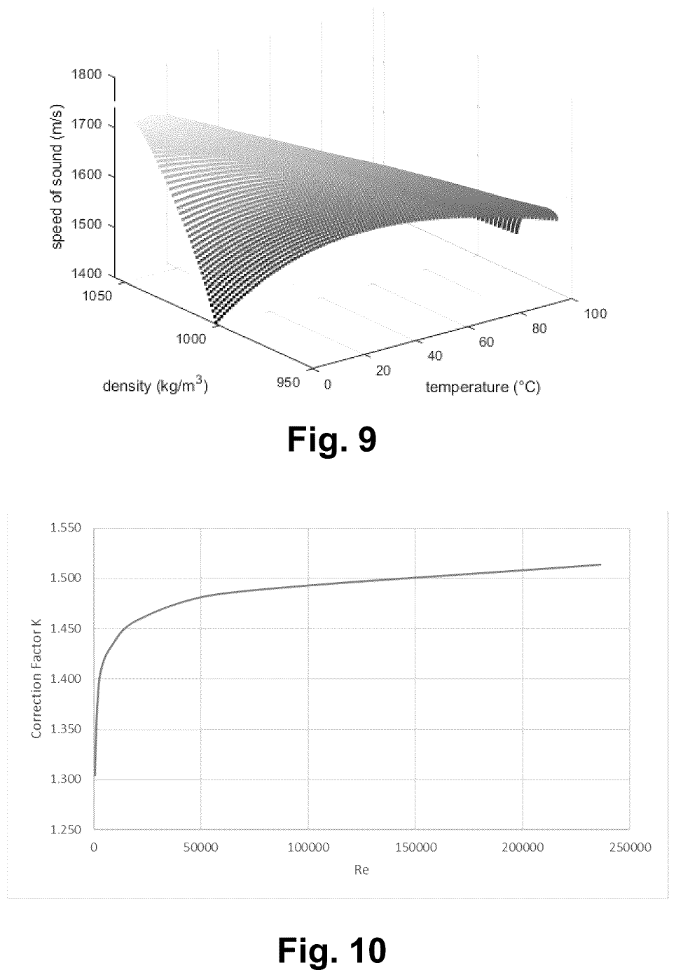

FIGS. 7, 8, 9 show defined relations of the kinematic viscosity v (mm²/s), the specific heat capacity cₚ (kj/kg/K), and the density ρ (kg/m³) in the fluid, respectively, and how these relate to the measured speed of sound (m/s) and the measured temperature (° C.). The relations specify a set of points in 3D space which correspond to possible physical states of the fluid, wherein the physical states of the fluid are defined by the temperature of the fluid, the speed of sound, and the kinematic viscosity (the relation shown in FIG. 7); the temperature of the fluid, the speed of sound, and the specific heat capacity (the relation shown in FIG. 8); and the temperature of the fluid, the speed of sound, and the density (the relation shown in FIG. 9).

The relations, and therefore the set of points, can be plotted as geometric shapes in the forms of curved two-dimensional surfaces as illustrated in FIGS. 7-9.

Depending on the embodiment, the relations can be stored, for example in the memory 22 of the controller 2, in the form of a data points (e.g., in a look up table), or using one or more coefficients of one or more functions (e.g., polynomial functions), or other methods for storing the relations directly or indirectly (e.g., by storing parameters which can be used, by the processing unit 21, to generate the relations and/or particular points of curves, as necessary).

The defined relations described herein may, in an embodiment, be implemented as a function and/or a look up table which include as variable inputs the speed of sound and the temperature and have as an output one or multiple values of the particular property of the fluid to be determined (e.g. the kinematic viscosity, the specific heat capacity, or the density). In an embodiment, the defined relations have as their only variable inputs the speed of sound and the temperature and have as an output one or multiple values of the particular property of the fluid to be determined. The reason why the defined relations may output two values is due to the fact that, for particular combinations of the temperature and the speed of sound, two values of the particular property to be determined (i.e., the kinematic viscosity, specific heat capacity or the density) may be physically possible. This ambiguity may be resolved as described herein by consideration of past values of the particular property.

In an example, each defined relation is implemented as a look-up table in which each combination of temperature and speed of sound is associated with the property to be determined.

In an example, each relation is implemented using a defined polynomial and an associated plurality of polynomial coefficients.

For example, a particular relation may be defined using a 3^{rd} or 4^{th} order polynomial. One or more exponential functions may also be used alone or in combination with the polynomial. Nested exponential functions may also be used. Additionally or alternatively, logarithmic functions may also be used.

For example, the defined relations described herein between speed of sound, temperature, and the further properties of the fluid (in particular density, specific heat capacity, and viscosity) may be represented, at least approximately, in three dimensions as quadric surfaces. The defined relations may therefore be expressed using quadratic equations. One or more of the defined relations may therefore be stored in the form of a defined quadratic equation in a particular functional form and with therewith associated particular coefficients. These FIGS. 7-9 show exemplary relations for a particular fluid composition, e.g., for a particular mixture of a binary fluid. Specifically, the Figures show exemplary relations for a water/glycol mixture at a specific glycol concentration.

The defined relation between speed of sound, viscosity, and temperature in the fluid defines, for each temperature and speed of sound value pair (i.e. for each combination of temperature and speed of sound), one or two values of the kinematic viscosity. The value(s) of the kinematic viscosity are defined for a plurality of values of the temperature between 0° C. and 100° C. (e.g., one value per degree centigrade). The value(s) of the kinematic viscosity are defined for a plurality of values of the speed of sound between 1400 m/s and 1800 m/s (e.g., one value for every 10 m/s). The value(s) of the kinematic viscosity lie in the range of 0 to 30 mm²/s. For some pairings (combinations) of temperature and speed of sound, in particular for a fluid which is a binary mixture of water and glycol, two values of the kinematic viscosity may be mathematically possible due to the curvature (in a 3D representation) of the relation.

The defined relation between speed of sound, specific heat capacity, and temperature in the fluid defines, for each temperature and speed of sound value pair (i.e. for each combination of temperature and speed of sound), one or two values of the specific heat capacity. The value(s) of the specific heat capacity are defined for a plurality of values of the temperature between 0° C. and 100° C. (e.g., one value per degree centigrade). The value(s) of the specific heat capacity are defined for a plurality of values of the speed of sound between 1400 m/s and 1800 m/s (e.g., one value for every 10 m/s). The value(s) of the specific heat capacity lie in the range of 3 to 4.5 KJ/kg/K. For some pairings (combinations) of temperature and speed of sound, in particular for a fluid which is a binary mixture of water and glycol, two values of the specific heat capacity may be mathematically possible due to the curvature (in a 3D representation) of the relation.

The defined relation between speed of sound, density, and temperature in the fluid defines, for each temperature and speed of sound value pair (i.e. for each combination of temperature and speed of sound), one or two values of the density. The value(s) of the density are defined for a plurality of values of the temperature between 0° C. and 100° C. (e.g., one value per degree centigrade). The value(s) of the density are defined for a plurality of values of the speed of sound between 1400 m/s and 1800 m/s (e.g., one value for every 10 m/s). The value(s) of the density lie in the range of 950 to 1050 kg/m³. For some pairings (combinations) of temperature and speed of sound, in particular for a fluid which is a binary mixture of water and glycol, two values of the density may be mathematically possible due to the curvature (in a 3D representation) of the relation.

Similar considerations apply to the further defined relations described herein, in particular the defined relations which relate viscosity and temperature to antifreeze concentration in the fluid, which relate density and temperature to antifreeze concentration in the fluid, and which relate specific heat capacity and temperature to antifreeze concentration.

Typically, the defined relations described herein are determined in a laboratory setting in which, in a tightly controlled environment, various fluid mixtures are prepared, brought to a specific set of temperatures, and whose properties (in particular, speed of sound, kinematic viscosity, specific heat capacity, and density) are measured using precise laboratory instruments. Subsequently, the determined relations are stored in the memory 22 of the controller 2 of the flowmeter 1, for example during manufacture of commissioning, such that the flowmeter 1 is enabled to determine, with great accuracy, the kinematic viscosity, the specific heat, and/or the density of the fluid using a relatively simple measurement setups as described herein, in particular with reference to FIGS. 3 to 6.

Depending on the embodiment, the relations can additionally or alternatively be retrieved by the controller 2 on demand, for example from the local gateway, from the remote server, or from another data storage system.

As each relation is associated with a particular fluid type and concentration (e.g. a particular mixture of water and a specific antifreeze type), a plurality of relations described herein, such as for each of the kinematic viscosity, the specific heat, and/or the density, can be stored for a specific set of fluids.

As can also be seen, the curvature of the surfaces of the relations as shown in FIGS. 7-9 is such that, for certain values of temperature, there does not exist an unambiguous mapping between speed of sound and the further fluid properties to be determined (i.e. the kinematic viscosity, the specific heat capacity, and/or the density). Therefore, a measured temperature of the fluid and a measured speed of sound in the fluid is not necessarily sufficient to unambiguously determine the further fluid properties.

Therefore, depending on the embodiment, recorded measurement values of the speed of sound and the temperature, and optionally also past determined values of the kinematic viscosity, the specific heat capacity, and/or the density, in particular values determined subsequent to installation and commissioning of the flowmeter 1, may be used to disambiguate the determined further properties in cases where more than one value would satisfy the relation.

In an embodiment, further functions, properties and/or quantities are associated with the one or more of the relations, and these can either be stored or generated as required. These include partial derivatives of the relations at particular points with respect to particular parameters and/or quantities including maxima, minima, inflection points, etc.

In an embodiment, new or updated relations are received by the controller 2 from the remote server for a particular fluid (e.g. a fluid having particular antifreeze type) and the controller 2 stores the updated relation for the particular fluid.

FIG. 10 shows a defined correction relation between the Reynolds number of a fluid, which can be determined using the viscosity of the fluid, and a correction factor k, which correction factor is used to determine a corrected flow velocity of a flow in the fluid using the measured flow velocity. The correction relation (resp. the correction factor k) depends on characteristics of how the flow velocity of the fluid is measured. For example, if the flow velocity is measured using transit times of ultrasonic pulses (as explained herein), the correction relation depends on the measurement path, i.e. the path of the ultrasonic pulses between the first and second ultrasonic transducers 34A, 34B. Specifically, the correction relation is different if the measurement path is diagonally across the channel 6 than if the measurement path is V or U shaped (as shown in FIGS. 3, 4, 5, respectively).

As is described below with reference to FIGS. 11 to 19, the one or more defined relations may be used to calculate properties of the fluid beyond those measured by the sensor system 3 directly (i.e., beyond the temperature, speed of sound, and fluid velocity). The one or more defined relations may also be used to correct particular measurements of fluid properties, in particular correcting the measured fluid velocity.

In an embodiment, the values of the properties of the fluid calculated according to the methods described herein are stored in the memory 22 by the processing unit 21. Each property of the fluid may be associated with one or more thresholds. The processing unit 21 may be configured to determine whether a value, in particular a current value, of a particular property of the fluid satisfies the one or more thresholds associated with it. The processing unit 21 may be configured to generate a message, in particular a notification message (the notification message could alternatively be an alarm message), if a property of the fluid does not satisfy the one or more associated thresholds. The notification message may be stored in the memory 22 and/or transmitted by the communication interface 23, for example to the remote server.

The steps described below with reference to FIGS. 11 to 19 are described as being performed by the processing unit 21 of the controller 2, however, depending on the embodiment, some or all of the steps, in whole or in part, described may also be performed by appropriate circuitry and/or functional modules of the sensor system 3, the gateway, and/or the remote server.

In a preparatory step S0 (not shown), the sensor system 3 measures the measurement data of the fluid, by measuring values directly and/or indirectly related to the temperature, the speed of sound, and the flow velocity. The sensor system 3 is configured to transmit the measurement data to the controller 2, in particular the processing unit 21.

In step S1 of FIG. 11, the processing unit 21 is configured to receive measurement data of the fluid. The measurement data is received from the sensor system 3 and relates to measured physical properties of the fluid, in particular including a measured temperature, a measured speed of sound, and a measured flow velocity.

The measurement data is optionally stored in the memory 22 and/or transmitted via the communication interface 23 to the remote server.

As explained above, the measurement data can received in various forms, including sensor signals from one or more sensors of the sensor system 3, intermediate values calculated using the sensor signals (in particular, transit times of ultrasonic pulses), or measured values of the physical properties.

In an embodiment, the controller 2 detects whether the measurement data of the fluid has changed. A change in the measurement data is detected by the processing unit 21, if the measurement data has changed greater than a predetermined amount. For example, if the measured speed of sound changes by more than 20 m/s within a time period of a week, a change is detected by the controller 2 and this change is stored in the memory 22. The detection of the change is, in an embodiment, transmitted by the controller 2 via the communication interface 23 to the remote server. Because the speed of sound depends on the temperature of the fluid, and the temperature of the fluid can vary in the HVAC system, in particular in the channel 6 over time, the processing unit 21, using the relation, takes into account variations in the speed of sound due to changes in the temperature when detecting a change. The processing unit 21 of the controller 2 proceeds beyond step S1 only if a change is detected.

In step S2, the processing unit 21 is configured to determine a viscosity of the fluid using the measurement data (in particular the measured speed of sound and the measured temperature). The viscosity is determined using the defined relation between speed of sound, temperature, and viscosity in the fluid. The defined relation is described in more detail herein, particular with reference to FIG. 7.

In step S3, the processing unit 21 is configured to determine a corrected flow velocity of the fluid, using the measured flow velocity and the determined viscosity.

In an embodiment, the corrected flow velocity is determined, in the processing unit 21, using a defined correction relation between the measured flow velocity and the determined viscosity in the fluid. The defined correction relation may be based on an analytical relationship (e.g., based on a first-principles physical analysis of fluid flow), or based on an experimentally established relationship (e.g., based on measurements of the fluid as performed in a laboratory). The defined correction relation is stored, for example, in the memory 22 of the controller 2. Depending on the embodiment, multiple correction relations may be stored for multiple types of fluid and/or fluid mixtures.

The corrected flow velocity u is determined from the measured flow velocity u according to the following relation:

$$\overline{u} = k \cdot u$$

where k is the correction factor according to the defined correction relation.

The corrected flow velocity is designed to reflect the average flow velocity of the fluid in the channel 6. The corrected flow velocity therefore accounts for different flow profiles which occur at different measured flow velocities.

In an embodiment, the defined correction relation between the measured flow velocity and the determined viscosity is further designed to account for diameter D of the channel 6 and the cross-sectional shape of the channel 6.

In an embodiment, the processing unit 21 is configured to calculate, using the determined viscosity, the Reynolds number Re of the fluid, as is described herein, in particular with reference to FIG. 10. The Reynolds number Re is related to the (kinematic) viscosity v according to the following relation:

$$R e = \frac{uL}{v}$$

where u is the measured flow velocity in the fluid (m/s), and L is a characteristic linear dimension (m).

Depending on the embodiment, the corrected flow velocity u is used directly, for example it is transmitted by the controller 2 to the remote server for monitoring and/or logging. The corrected flow velocity ū may also be displayed on a display of the controller 2, or transmitted via a wired or wireless interface to a tool device in communicative connection with the controller 2.

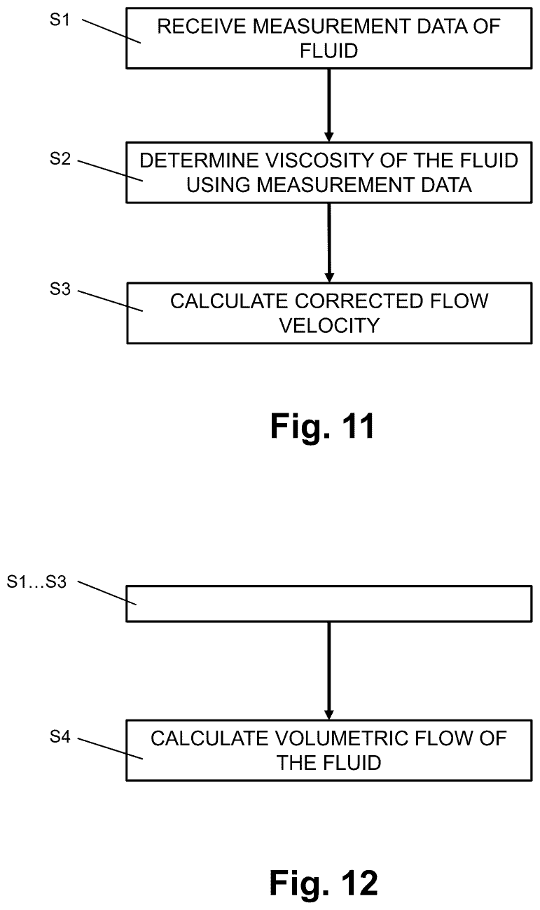

The corrected flow velocity ū can further be used to calculate other properties of the fluid, or of the HVAC system through which the fluid flows, more accurately, as is described in more detail below with reference to FIGS. 12 to 18.

In an embodiment, the controller 2, in particular the processing unit 21 of the controller is configured to receive the corrected flow velocity ū and to generate and transmit a control signal to the actuator 5 of the valve 4, for controlling the flow of the fluid, according to the corrected flow velocity ū and a defined flow set point. The defined flow set point may be retrieved from the memory 22 or received via the communication interface 23.

FIG. 12 shows, in addition to steps S1 . . . . S3 which are described above with reference to FIG. 10, a step S4 in which the processing unit 21 is configured to calculate the volumetric flow of the fluid through the channel 6. The volumetric flow of the fluid is calculated using the cross-sectional area A of the channel 6. The cross-sectional area may be determined using the diameter D and a factor depending on the cross-sectional shape.

As explained above with the corrected flow velocity ū, the volumetric flow can be displayed or provided by the controller 2 to a user directly, or transmitted to the remote server for monitoring and/or logging, etc.

As explained above with respect to the corrected flow velocity ū, the volumetric flow may also be used by the controller 2 for controlling an actuator 5 of a valve 4 according to the volumetric flow and a defined volumetric flow set point. In particular, the processing unit 21 of the controller is configured to receive the volumetric flow and to generate and transmit a control signal to the actuator 5 of the valve 4, for controlling the volumetric flow of the fluid, according to the volumetric flow and a defined volumetric flow set point. The defined volumetric flow set point may be retrieved from the memory 22 or received via the communication interface 23.

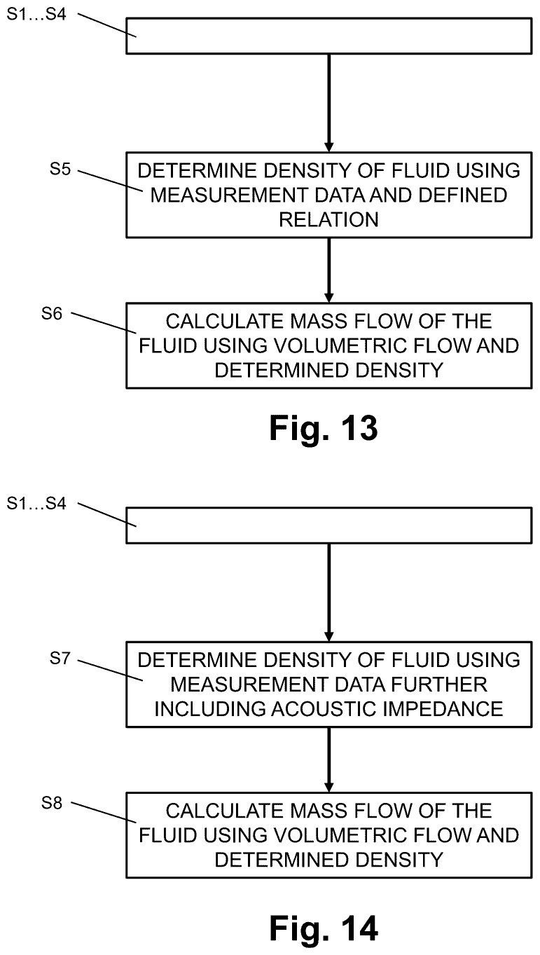

FIG. 13 shows, in addition steps S1 . . . . S4 as described above, step S5 in which the processing unit 21 is configured to determine a density ρ of the fluid, using the measurement data (in particular the measured speed of sound and the measured temperature) and a defined relation between speed of sound, density, and temperature in the fluid. The defined relation is explained above in more detail with reference to FIG. 9.

In a step S6, a mass flow of the fluid is calculated in the processing unit 21 using the determined density ρ and the volumetric flow previously calculated. The mass flow is, in particular, calculated as a product of the density ρ and the volumetric flow.

As above, the mass flow can be provided by the controller 2 to a user (via a display of the flowmeter 1), transmitted to a tool device, or transmitted to the remote server.

As explained above, the mass flow may also be used by the controller 2 for controlling an actuator 5 of a valve 4. In particular, the processing unit 21 of the controller is configured to receive the mass flow and to generate and transmit a control signal to the actuator 5 of the valve 4, for controlling the mass flow of the fluid, according to the mass flow and a defined mass flow set point. The defined mass flow set point may be retrieved from the memory 22 or received via the communication interface 23.

FIG. 14 shows a sequence of alternate steps for determining the mass flow. Steps S1 . . . . S4 as shown are described above with reference to FIGS. 11 and 12. In a step S7, the processing unit 21 is configured to determine the density of the fluid using the measurement data, the measurement data further including the acoustic impedance in the fluid. The acoustic impedance is determined, for example, by measuring the amplitude of SAWs between the ultrasonic transducers 34A, 34B as described above in more detail with reference to FIG. 6. The processing unit 21 is configured to determine the density, as mentioned, using the measured acoustic impedance and the measured speed of sound, and a defined relation between density, speed of sound, and acoustic impedance in the fluid.

In the step S6, the processing unit 21 is configured to determine the mass flow of the fluid using the volumetric flow and the determined density, as described above with reference to FIG. 13.

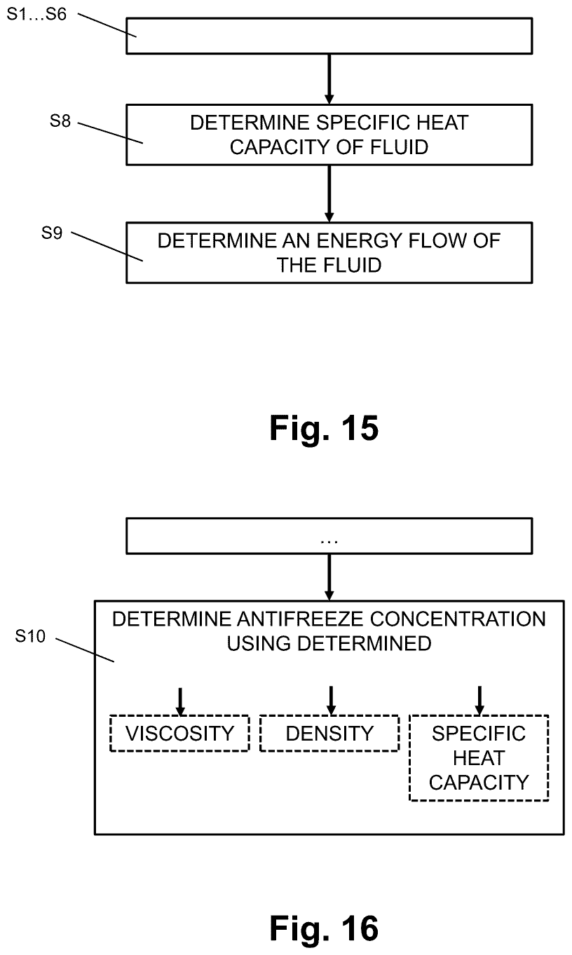

FIG. 15 shows a series of steps for determining an energy flow of the fluid. Steps S1 . . . . S6 are performed as described above with reference to FIGS. 11-14. In a step S8, the processing unit 21 is configured to determine the specific heat capacity of the fluid, using the measurement data (in particular the measured speed of sound and the measured temperature), and the defined relation between speed of sound, specific heat capacity, and temperature in the fluid. The defined relation is described in more detail above with reference to FIG. 8.

In a step S9, the processing unit 21 is configured to calculate an energy flow of the fluid, using the mass flow and the determined specific heat capacity. In particular, the energy flow is calculated as a product of the mass flow and the determined specific heat capacity.

By calculating the energy flow as described herein, it is possible to arrive at an accurate measure of the energy flow. Prior known methods of determining the energy flow require knowledge of the antifreeze concentration of the fluid, which, as described above, is subject to an error of 2%, therefore leading to the resultant energy flow having an error of at least 2%, which is too high for certain uses.

The above steps described with reference to FIGS. 11-15 apply to all manner of fluids, including mixtures. However, the fluid does not have to be a mixture.

The energy flow may be provided by the controller 2 to a user (e.g., via a display of the flowmeter 1), transmitted to a tool device, and/or transmitted to the remote server.

As explained above, the energy flow may also be used by the controller 2 for controlling an actuator 5 of a valve 4. In particular, the processing unit 21 of the controller is configured to receive the energy flow and to generate and transmit a control signal to the actuator 5 of the valve 4, for controlling the energy flow of the fluid, according to the energy flow and a defined energy flow set point. The defined energy flow set point may be retrieved from the memory 22 or received via the communication interface 23.

FIG. 16 shows a step S10 which applies to a fluid containing antifreeze, for example a water/glycol mixture.

In the step S10, the processing unit 21 is configured to determine an antifreeze concentration in the fluid using the determined density, the determined viscosity, and/or the determined specific heat capacity. The density, viscosity, and/or the heat capacity are determined as described herein, using the defined relations as described with reference to FIGS. 7 to 9.

Each of the physical properties of density, viscosity, and/or heat capacity are further dependent on the antifreeze concentration and the temperature.

The processing unit 21 is configured to determine the antifreeze concentration in the fluid using one of more of the determined density, the determined viscosity, and/or the determined heat capacity of the fluid.

For example, the processing unit 21 is configured to determine a first antifreeze concentration value using the measurement data (in particular the measured temperature), the determined viscosity, and a defined relation between viscosity, temperature, and antifreeze concentration.

For example, the processing unit 21 is configured to determine a second antifreeze concentration value using the measurement data (in particular the measured temperature), the determined density, and a defined relation between density, temperature, and antifreeze concentration.

For example, the processing unit 21 is configured to determine a third antifreeze concentration value using the measurement data (in particular the measured temperature), the determined specific heat capacity, and a defined relation between specific heat capacity, temperature, and antifreeze concentration.

The antifreeze concentration of the fluid is determined, in the processing unit 21, for example, by using an average of the first, second, and/or third values determined as described above. Other statistical measures can also be used. In particular a variance, or range of values can also be calculated in the processing unit 21 as a measure of uncertainty.

In an embodiment, the antifreeze concentration of the fluid is determined by using the measured speed of sound, the measured temperature, and a pre-defined relation between speed of sound, antifreeze concentration, and temperature in the fluid.

The antifreeze concentration of the fluid as determined above is more accurate than previous methods for determining the antifreeze concentration of the fluid using a measured speed of sound and a measured temperature. This is because, as explained herein, reference tables (i.e. relations) between antifreeze concentration, speed of sound, and temperature, have a relatively large uncertainty owing to the difficulty in preparing water/glycol mixtures of known proportions, or of measuring the glycol proportion in a fluid of unknown mixing ratio. This is further because the above described steps of determining the antifreeze concentration by first determining one or more of: the density, the viscosity, and/or the specific heat capacity, each via separate defined relations, is accurate, and also because the subsequent step(s) of determining the antifreeze concentration via defined relations between: density, temperature, and antifreeze concentration; viscosity, temperature, and antifreeze concentration; and/or specific heat capacity, temperature, and antifreeze concentration, are also highly accurate.

In an embodiment, one or more differences between the first, second, and/or third values are calculated. The processing unit 21 is configured to detect a change in the fluid characteristics, if one of the one or more differences in the determined antifreeze concentrations exceed a defined difference threshold. The fluid characteristics relate to a change in the type of fluid if it is a fluid of a single type, or of one or both components of the fluid, if the fluid is a binary mixture. In particular, the fluid characteristics may include a type of antifreeze in the fluid.

The particular defined relations mentioned above with reference to FIG. 16 are stored in the memory 22 as described for the other defined relations described herein, and are also established in a laboratory setting.

In an embodiment, the processing unit 21 is further configured to determine a freezing point of the fluid. The freezing point of the fluid is determined using a defined relation between the antifreeze concentration and the freezing point.

Additionally or alternatively, the processing unit 21 is configured to determine the freezing point of the fluid using the measurement data (in particular the measured speed of sound and the measured temperature), and a defined relation between speed of sound, temperature, and freezing point in the fluid.

In an embodiment, the processing unit 21 is further configured to generate a warning message, if the measured temperature is within a pre-defined safety threshold relative of the freezing point of the fluid. For example, if the measured temperature is 5° C. higher or less than the antifreeze temperature, then the warning message is generated.

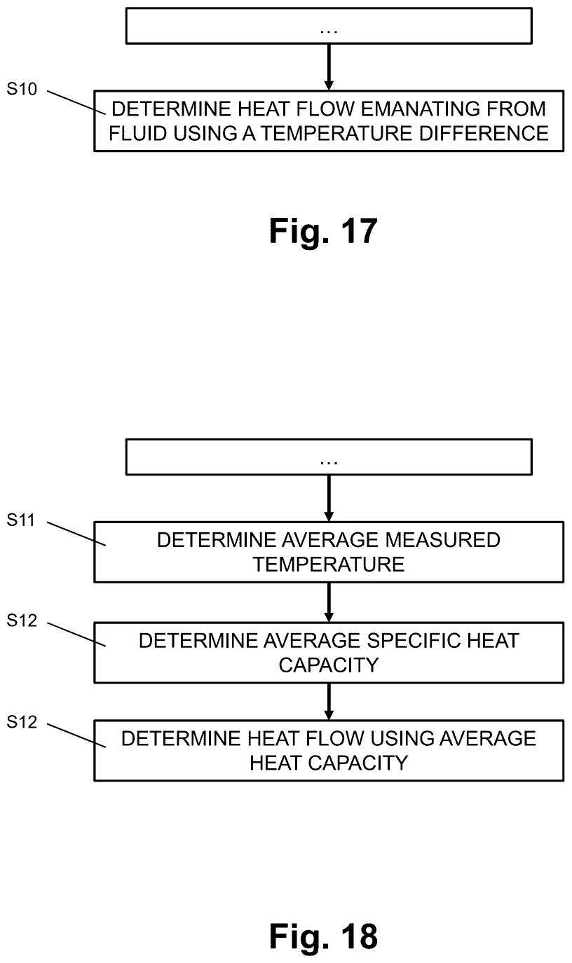

FIG. 17 relates to an embodiment in which the sensor system 3 includes a temperature sensor at the second position, such that a temperature difference is determined by the sensor system 3, in particular a temperature difference across a consumer device, such as a heat exchanger. In a step S11, the processing unit 21 determines the heat flow emanating from the fluid. The heat flow is calculated using the determined density, the determined specific heat capacity, the volumetric flow, and the temperature difference between the first and second temperature measurement.

FIG. 18 relates to an embodiment in which the heat flow is to be determined with higher accuracy. A calculated heat flow (for example, calculated as described above with reference to FIG. 17), is dependent on the specific heat capacity. However, the specific heat capacity is dependent on the temperature of the fluid. Therefore, an accurate calculation of the heat flow must take into account that the specific heat capacity of the fluid changes as the temperature changes.

In a step S11, an average measured temperature is determined in the processing unit 21, using the first measured temperature and the second measured temperature. For example, the average is a mean of the two measured temperatures.

In a step S12, the processing unit 21 is configured to determine an average heat capacity by calculating the heat capacity as described above with reference to FIG. 15.

Additionally or alternatively, the average heat capacity can also be calculated by determining a first value of the heat capacity using the first measured temperature and a second value of the heat capacity using the second measured temperature, and then averaging the first and second values.

In a step S13, the heat flow is determined using the density, the average specific heat capacity, the volumetric flow, and a temperature difference between the first temperature measurement and the second temperature measurement, in particular as a product of the aforementioned.

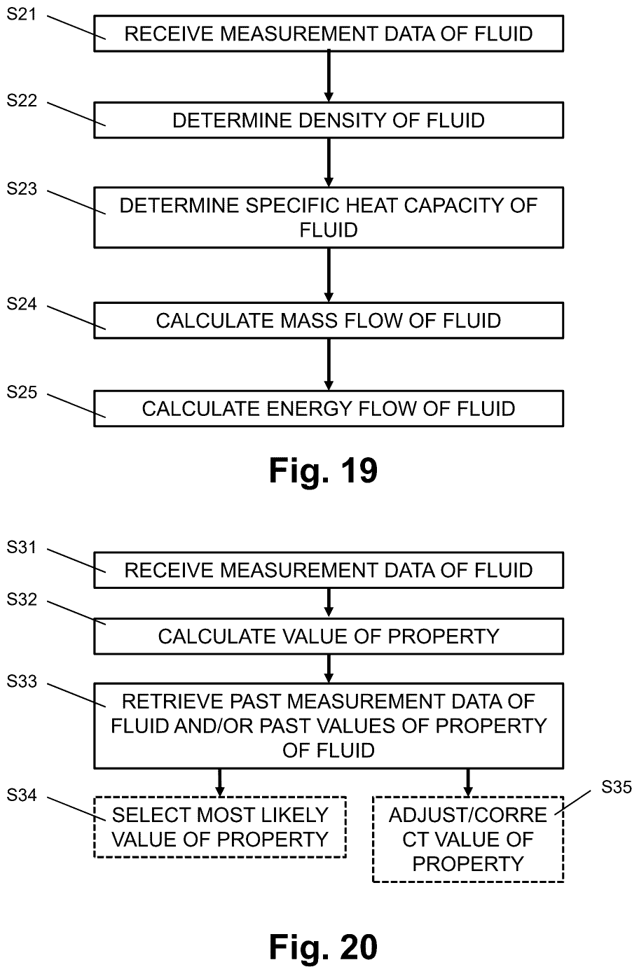

FIG. 19 relates to an embodiment in which an energy flow of the fluid in the channel 6 is determined.

In a preparatory step S0 (not shown), the sensor system 3 measures the measurement data of the fluid, by measuring values directly and/or indirectly related to the temperature, the speed of sound, and the flow velocity.

In a step S21, the processing unit 21 receives the measurement data of the fluid.

In a step S22, the processing unit 21 determines a density of the fluid, using the measurement data (in particular, the measured temperature and the measured speed of sound), and the defined relation between speed of sound, density, and temperature in the fluid described above with reference to FIG. 9.

In a step S23, the processing unit 21 determines the specific heat capacity of the fluid, using the measurement data (in particular, the measured temperature and the measured speed of sound), and the defined relation between speed of sound, specific heat, and temperature in the fluid described above with reference to FIG. 8.

In a step S24, the processing unit 21 calculates a mass flow of the fluid, using the measured flow velocity of the fluid, a cross-sectional area of the channel 6, and the determined density of the fluid.

In a step S26, the processing unit 21 calculates the energy flow of the fluid, using the determined mass flow and the determined specific heat capacity.

In an embodiment, the processing unit 21 is further configured to determine the heat flow emanating from the fluid as described above with reference to step S10 in FIG. 17.

In an embodiment, the processing unit 21 is further configured to determine the heat flow using an average specific heat capacity as described above with reference to step S12 of FIG. 18.

In an embodiment, the processing unit 21 is further configured to determine the heat flow, in particular using one of the methods and/or steps described herein, for a defined duration of time. For example, the heat flow at a plurality of time-points may be summed and/or integrated, taking into account the duration between each time-point, to calculate a total amount of heat transferred. The total amount of heat transferred or, in other words, the total thermal energy consumption, may be expressed in Joules or British Thermal

Units (BTU), for example. The total amount of heat transferred may be provided to the user using techniques described herein, stored to memory, and/or transmitted to a further device using the communication interface 23.

The heat flow may be positive, in the example of heat being transferred from the fluid to the environment. The heat flow may also be negative, in the example of heat being transferred from the environment to the fluid (e.g. in cooling applications).

In one example, the processing unit 21 is configured to maintain, in the memory 22, a total amount of heat flow. The total amount of heat flow may include one or more values indicative of the total amount of heat flow for one or more defined periods, for a current day, a current month, a current year, and/or a current billing cycle. The processing unit 21 may be configured to update the total amount of heat flow, for example periodically or in real-time, using the current heat flow.

FIG. 20 shows a method for disambiguation of fluid property values, in particular for specific combinations or pairings of a measured temperature and measured speed of sound for which the herein described relations between these measured values and the values of further properties of the fluid (specifically the viscosity, specific heat capacity, and density) allow for two possible values of a particular further properties. The method includes steps S31-S35. At least some of the steps S31-S35 may be performed as part of other methods described herein. Steps S34 and S35 are optional steps in that one and/or both of them may be performed. The method may be performed by the processing unit 21 of the controller 2.

In step S31, the measurement data of the fluid is received, for example as described above in step S1 as shown in FIG. 11. The measurement data of the fluid is preferably received substantially in real-time, in particular immediately or shortly after having been measured by one or more sensors. The measurement data therefore relates to a current state, or a substantially current state of the fluid.

In step S32, the measurement data of the fluid, in particular the current measurement data of the fluid, is used to calculate a value of a particular property (e.g., the viscosity, density, and/or specific heat capacity) of the fluid using a particular defined relation (as described with reference to FIGS. 7 to 9) between the measurement data and the particular property.

Optionally, the measurement data and/or the calculated value of the particular property is recorded, for example in the memory 22 of the controller 2. The measurement data and/or the calculated value may be recorded at defined intervals and/or at defined points in time, for example every second, every minute, or on the minute.

Optionally, statistical analysis of the measurement data and/or the calculated value of the particular property is performed. For example, an average value, for example a moving average over a pre-defined preceding time interval (for example, a moving average during the past hour) is calculated and/or recorded in the memory 22.

In step S33, past measurement data and/or past values of the particular property are retrieved, for example from the memory 22. Additionally and/or alternatively, one or more values associated with the past measurement data and/or past values of the particular property are retrieved.

In particular, the past measurement data and/or the past values of the particular property refer to measured and/or calculated values, respectively, for the particular fluid of the HVAC system. In other words, the past measurement data and/or past values of the particular property go back in time at earliest to a time-point of installation and/or commissioning of the controller 2. In an example, the past measurement data and/or past values of the particular property go back in time at earliest to a time-point of a refill and/or exchange of the fluid of the HVAC system of which the flowmeter 1 is a component.

The past measurement data relates to one or more temperature measurements and/or one or more speed of sound measurements of the fluid at one or more time-points in the past. For example, the time-points may include or define a measurement log of a sequence of measurement data, for example recorded at regular intervals. Values associated with the past measurement data may include data derived from or calculated using the past measurement data, such as a moving average, a rate of change, or functions thereof.

The past values of the particular property relate to one or more calculated values of the particular property (e.g., viscosity, specific heat capacity, and/or density) of the fluid at one or more time-points in the past. For example, the time-points may include or define a measurement log of a sequence of values of the particular property, for example recorded at regular intervals. Further values associated with the particular property may include data derived from or calculated using the value of the particular property, such as a moving average, a rate of change (in particular a partial derivative), or functions thereof.

The past measurement data and/or the past values of particular property may be used to disambiguate the current value of the property if there are two mathematically possible values of the particular for the current measurement data, in particular the currently measured temperature and the currently measured speed of sound.

The past measurement data may of course be used to (re) calculate past values of the particular property using the particular defined relation(s).

The past measurement data and/or the past values of the particular property are used, by the processing unit, to calculate the value of the particular property.

In step S34, which is an optional step, the value of the particular property are calculated by selecting, using the past measurement data and/or the past values of the particular property, the most likely value of the particular property. Specifically, in a situation where the measurement data provides an ambiguous value of the particular property, i.e. two values of the particular property satisfy the particular defined relation, the past measurement data and/or the past values of the particular property are used to select the one value of the particular property which is most likely to represent the actual, physical value of the particular property. The assumption that is made is that the actual, physical value of the particular property changes slowly over time.

For example, if, at a current point in time and using current measurement values, two values of the particular property satisfy the particular defined relation, one or more past values (or a valued derived therefrom, such as a moving average) of the particular property (e.g., a most recent past value of the particular property) is compared to the two values which satisfy the particular defined relation. The value which lies closest to the one or more past values (or the value derived therefrom, such as the moving average) is selected as the value of the particular property.

In step S35, which is an optional step, the value of the particular property is calculated by adjusting and/or correcting the value of the particular property using the past measurement data and/or the past values of the particular property. Specifically, a calculated value of the particular property, calculated using current measurement data, may be adjusted and/or corrected on the basis of past values of the particular property. For example, a moving average of one or more past values of the particular property may be used to determine a smoothed value of the particular property. In such a manner, outliers resulting from erroneous measurements may be corrected for.

The above-described embodiments of the disclosure are exemplary and the person skilled in the art knows that at least some of the components and/or steps described in the embodiments above may be rearranged, omitted, or introduced into other embodiments without deviating from the scope of the present disclosure.

### CLAUSES

1. A method for determining the flow of a fluid in a channel, in particular in which the fluid is a mixture of at least two different fluids, the method comprising:
   receiving, in a processing unit, measurement data of the fluid, the measurement data comprising a measured flow velocity of the fluid, a measured temperature of the fluid, and a measured speed of sound in the fluid;
   determining, in the processing unit, a viscosity of the fluid, using the measurement data and a defined relation between speed of sound, viscosity, and temperature in the fluid; and
   calculating, in the processing unit, a corrected flow velocity of the fluid, using the measured flow velocity and the determined viscosity.
2. The method of clause 1, wherein the method comprises calculating the corrected flow velocity further using a defined correction relation, wherein the defined correction relation depends on the determined viscosity.
3. The method of clause 2, wherein the method comprises calculating the Reynolds number of the fluid using the viscosity, and the defined correction relation depends on the Reynolds number of the fluid.
4. The method of one of clauses 1 to 3, wherein the method comprises calculating the corrected flow velocity of the fluid further using a flow measurement correction factor that depends on characteristics of how the flow velocity of the fluid is measured and/or of the flow velocity distribution.
5. The method of one of clauses 1 to 4, further comprising:
   calculating, in the processing unit, a volumetric flow of the fluid, using the corrected flow velocity of the fluid and a cross-sectional area of the channel.
6. The method of clause 5, further comprising:
   determining, in the processing unit, a density of the fluid, using the measurement data and a defined relation between speed of sound, density, and temperature in the fluid; and
   calculating, in the processing unit, a mass flow of the fluid, using the volumetric flow of the fluid and the determined density of the fluid.
7. The method of clause 5, wherein the measurement data further comprises an acoustic impedance in the fluid, the method further comprises:
   determining, in the processing unit, a density of the fluid, using the measurement data and a defined relation between speed of sound, density, and acoustic impedance in the fluid; and
   calculating, in the processing unit, a mass flow of the fluid, using the volumetric flow of the fluid and the determined density of the fluid.
8. The method of one of clauses 6 or 7, further comprising:
   determining, in the processing unit, a specific heat capacity of the fluid, using the measurement data and a defined relation between speed of sound, specific heat capacity, and temperature in the fluid; and
   calculating, in the processing unit, an energy flow of the fluid, using the mass flow and the determined specific heat capacity.
9. The method of one of clauses 1 to 8, the fluid being of at least two different fluids, wherein one of the fluids is an antifreeze, and the method further comprises:
   determining, in the processing unit, an antifreeze concentration in the fluid using one or more of:
      the measurement data, the determined viscosity, and a defined relation between viscosity, temperature, and antifreeze concentration in the fluid,
      the measurement data, the determined density, and a defined relation between density, temperature, and antifreeze concentration in the fluid, or
      the measurement data, the determined specific heat capacity, and a defined relation between specific heat capacity, temperature, and antifreeze concentration in the fluid.
10. The method of clause 9, further comprising:
   calculating, in the processing unit, using the antifreeze concentrations determined using at least two of: the viscosity, the density, or the specific heat capacity, one or more differences in the determined antifreeze concentrations; and
   detecting, in the processing unit, a change in the fluid characteristics, in particular a change in the type of antifreeze in the fluid, if one of the one or more differences in the determined antifreeze concentrations exceed a defined difference threshold.
11. The method of one of clauses 9 or 10, further comprising:
   determining, in the processing unit, a freezing point of the fluid, using the antifreeze concentration and a defined relation between antifreeze concentration and freezing point.
12. The method of one of clauses 1 to 11, further comprising:
   determining, in the processing unit, a freezing point of the fluid, using the measurement data and a defined relation between speed of sound, freezing point, and temperature in the fluid.
13. The method of one of clauses 5 to 12, wherein the measurement data includes a second measured temperature of the fluid measured at a position different from the first measured temperature, and the method further comprises:
   determining, in the processing unit, the heat flow emanating from the fluid, using the density, the specific heat capacity, the volumetric flow, and a temperature difference between the first temperature measurement and the second temperature measurement.
14. The method of clause 13, wherein the method further comprises:
   determining, in the processing unit, an average measured temperature using the first measured temperature and the second measured temperature;
   determining, in the processing unit, an average specific heat capacity using the measured speed of sound, the average measured temperature, and the defined relation between speed of sound, specific heat capacity, and temperature in the fluid; and
   determining, in the processing unit, the heat flow using the density, the average specific heat capacity, the volumetric flow, and a temperature difference between the first temperature measurement and the second temperature measurement.
15. A method for determining an energy flow of a fluid in a channel, in particular in which the fluid is a mixture of at least two different fluids, wherein the method comprises:
   receiving, in a processing unit, measurement data of the fluid, the measurement data comprising a measured flow velocity of the fluid, a first measured temperature of the fluid, and a measured speed of sound in the fluid;
   determining, in the processing unit, a density of the fluid, using the measurement data and a defined relation between speed of sound, density, and temperature in the fluid;
   determining, in the processing unit, a specific heat capacity of the fluid, using the measurement data and a defined relation between speed of sound, specific heat capacity, and temperature in the fluid;
   calculating, in the processing unit, a mass flow of the fluid, using the flow velocity of the fluid, a cross-sectional area of the channel, and the determined density of the fluid; and
   calculating, in the processing unit, an energy flow of the fluid, using the mass flow and the determined specific heat capacity.
16. The method of clause 15, wherein the measurement data includes a second measured temperature of the fluid measured at a position different from the first measured temperature, and the method further comprises:
   determining, in the processing unit, the heat flow emanating from the fluid, using the density, the specific heat capacity, the volumetric flow, and a temperature difference between the first temperature measurement and the second temperature measurement.
17. The method of clause 16, further comprising:
   determining, in the processing unit, an average measured temperature using the first measured temperature and the second measured temperature;
   determining, in the processing unit, an average specific heat capacity using the measured speed of sound, the average measured temperature, and the defined relation between speed of sound, specific heat capacity, and temperature in the fluid; and
   determining, in the processing unit, the heat flow using the density, the average specific heat capacity, the volumetric flow, and a temperature difference between the first temperature measurement and the second temperature measurement.
18. The method of one of clauses 1 to 17, further comprising:
   retrieving, by the processing unit, one or more of: past measurement data or a past value of a particular fluid property, the fluid property value relating to one or more of: the corrected flow velocity, the volumetric flow, the mass flow, or the energy flow; and
   calculating, by the processing unit, a current value of the particular fluid property using, in addition to the measurement data, one or more of: the past measurement data or the past value of the particular fluid property.
19. The method of one of clauses 1 to 18, further comprising:
   receiving, in the processing unit, a defined set point, wherein the defined set point relates to one or more of: a flow set point, a volumetric flow set point, a mass flow set point, or energy flow set point;
   generating, in the processing unit, a control signal using the defined set point and a fluid property value, wherein the fluid property value relates to one or more of: the corrected flow velocity, the volumetric flow, the mass flow, or the energy flow; and
   controlling, in the processing unit, an actuator connected to a valve using the control signal.
20. The method of one of clauses 1 to 19, further comprising:
   determining, in the processing unit, whether the fluid satisfies one or more defined thresholds, using one or more of: the measurement data or a value of a property of the fluid, the one or more defined thresholds associated with one or more of: the measurement data or the value of the property of the fluid, respectively; and
   generating, in the processing unit, a notification message, if the fluid does not satisfy the one or more defined thresholds.
21. A device for determining the flow of a fluid in a channel, comprising a processing unit configured to perform the method according to one of clauses 1 to 20.
22. The device of clause 21, further comprising a sensor system connected to the processing unit and configured to:
   measure a flow velocity of the fluid, a speed of sound in the fluid, and a temperature of the fluid; and
   transmit measurement data to the processing unit, the measurement data including the flow velocity of the fluid, the speed of sound in the fluid, and the temperature of the fluid.
23. The device of one of clauses 21 or 22, further comprising a sensor system including an ultrasonic measurement assembly.
24. The device of clause 23, wherein the ultrasonic measurement assembly includes two ultrasonic transducers coupled to the channel and wherein the ultrasonic measurement assembly is configured to:
   measure transit times of surface acoustic waves between the ultrasonic transducers;
   determine one or more of the following properties of the fluid using the transit times: a flow velocity, a speed of sound, a temperature, or an acoustic impedance; and
   transmit measurement data to the processing unit, the measurement data including the one or more determined properties of the fluid.
25. The device of one of clauses 21 to 24, wherein the sensor system includes a first temperature sensor arranged at a first position.
26. The device of clause 25, wherein the sensor system includes a second temperature sensor arranged at a second position, wherein the second position is on an opposing side of a consumer device, in flow direction, with respect to the first position.
27. A computer program product comprising computer program code configured to control a processing unit of a device such that the device performs the steps according to the method of one of clauses 1 to 20.

1-27. (canceled)

28. A method for determining an energy flow of a fluid in a channel, in particular in which the fluid is a mixture of at least two different fluids, the method comprising:
measuring, in a sensor system, measurement data of the fluid, the measurement data comprising a measured flow velocity of the fluid, a measured temperature of the fluid, and a measured speed of sound in the fluid;
receiving, in a processing unit, the measurement data of the fluid;
determining, in the processing unit, a viscosity of the fluid, using the measured speed of sound, the measured temperature, and a defined relation between speed of sound, temperature, and viscosity in the fluid;
calculating, in the processing unit, a corrected flow velocity of the fluid, using the measured flow velocity and the determined viscosity;
calculating, in the processing unit, a volumetric flow of the fluid using the corrected flow velocity of the fluid and a cross-sectional area of the channel;
determining, in the processing unit, a density of the fluid, using the measured speed of sound, the measured temperature, and a defined relation between speed of sound, temperature, and density in the fluid;
calculating, in the processing unit, a mass flow of the fluid, using the volumetric flow of the fluid and the determined density of the fluid;
determining, in the processing unit, a specific heat capacity of the fluid, using the measured speed of sound, the measured temperature, and a defined relation between speed of sound, temperature, and specific heat capacity in the fluid; and
calculating, in the processing unit, an energy flow of the fluid, using the mass flow and the determined specific heat capacity.

29. The method of claim 28, wherein the method comprises calculating the corrected flow velocity further using a defined correction relation, wherein the defined correction relation depends on the determined viscosity.

30. The method of claim 29, wherein the method comprises calculating the Reynolds number of the fluid using the viscosity, and the defined correction relation depends on the Reynolds number of the fluid.

31. The method of claim 29, wherein the method comprises calculating the corrected flow velocity of the fluid further using a flow measurement correction factor that depends on characteristics of how the flow velocity of the fluid is measured and/or of the flow velocity distribution.

32. The method of claim 28, wherein the measurement data further comprises an acoustic impedance in the fluid, the method further comprises:
determining, in the processing unit, the density of the fluid further using the measured speed of sound, the measured acoustic impedance, and a defined relation between speed of sound, acoustic impedance, and density in the fluid; and
calculating, in the processing unit, the mass flow of the fluid, further using the volumetric flow of the fluid and the density of the fluid determined using the acoustic impedance.

33. The method of claim 28, wherein the measurement data includes a second measured temperature of the fluid measured at a position different from the first measured temperature, and the method further comprises:
determining, in the processing unit, a heat flow emanating from the fluid, using the determined density, the determined specific heat capacity, the calculated volumetric flow, and a temperature difference between the first temperature measurement and the second temperature measurement.

34. The method of claim 33, further comprising:
determining, in the processing unit, an average measured temperature using the first measured temperature and the second measured temperature;
determining, in the processing unit, an average specific heat capacity using the measured speed of sound, the average measured temperature, and the defined relation between speed of sound, specific heat capacity, and temperature in the fluid; and
determining, in the processing unit, the heat flow using the density, the average specific heat capacity, the volumetric flow, and a temperature difference between the first temperature measurement and the second temperature measurement.

35. The method of claim 28, further comprising:
receiving, in the processing unit, a defined set point, wherein the defined set point relates to one or more of: a flow set point, a volumetric flow set point, a mass flow set point, or an energy flow set point;
generating, in the processing unit, a control signal using the defined set point and a fluid property value, wherein the fluid property value corresponds to the defined set point and relates to one or more of: the corrected flow velocity, the volumetric flow, the mass flow, or the energy flow; and
controlling, in the processing unit, an actuator connected to a valve using the control signal.

36. The method of claim 28, further comprising:
determining, in the processing unit, whether the fluid satisfies one or more defined thresholds, using one or more of: the measurement data or a fluid property value, the one or more defined thresholds associated with one or more of: the measurement data or the fluid property value, respectively; and
generating, in the processing unit, a notification message, if the fluid does not satisfy the one or more defined thresholds.

37. A method for determining a flow of a fluid in a channel, in particular in which the fluid is a mixture of at least two different fluids, the method comprising:
measuring, in a sensor system, measurement data of the fluid, the measurement data comprising a measured flow velocity of the fluid, a measured temperature of the fluid, and a measured speed of sound in the fluid;
receiving, in a processing unit, the measurement data of the fluid;
determining, in the processing unit, a viscosity of the fluid, using the measured speed of sound, the measured temperature, and a defined relation between speed of sound, temperature, and viscosity in the fluid;
calculating, in the processing unit, a corrected flow velocity of the fluid, using the measured flow velocity and the determined viscosity;
retrieving, by the processing unit, one or more of: past measurement data or a past value of the corrected flow velocity; and
calculating, by the processing unit, a current value of the corrected flow velocity using, in addition to the calculated corrected flow velocity of the fluid, one or more of: the past measurement data or the past value of the corrected flow velocity.

38. A method for determining the flow of a fluid in a channel, the fluid being a mixture of at least two different fluids, wherein one of the fluids is an antifreeze, the method comprising:
measuring, in a sensor system, measurement data of the fluid, the measurement data comprising a measured flow velocity of the fluid, a measured temperature of the fluid, and a measured speed of sound in the fluid;
receiving, in a processing unit, the measurement data of the fluid;
and determining, in the processing unit, an antifreeze concentration in the fluid using one or more of the following sequences of steps:
determining a viscosity of the fluid, the viscosity determined using the measured temperature, the measured speed of sound, and a defined relation between temperature, speed of sound, and viscosity in the fluid, and determining the antifreeze concentration in the fluid using the determined viscosity, the measured temperature, and a defined relation between viscosity, temperature, and antifreeze concentration in the fluid;
determining a density of the fluid, the density determined using the measured temperature, the measured speed of sound, and a defined relation between temperature, speed of sound, and density in the fluid, and determining the antifreeze concentration in the fluid using the determined density, the measured temperature and a defined relation between density, temperature and antifreeze concentration in the fluid; or
determining a specific heat capacity of the fluid, the specific heat capacity determined using the measured temperature, the measured speed of sound, and a defined relation between temperature, speed of sound, and specific heat capacity, and determining the antifreeze concentration in the fluid using the determined specific heat capacity, the measured temperature, and a defined relation between specific heat capacity, temperature, and antifreeze concentration in the fluid.

39. The method of claim 38, further comprising:
determining, in the processing unit, a plurality of values of the antifreeze concentration in the fluid using two or more of the sequences of steps; and
determining, in the processing unit, a further value of the antifreeze concentration in the fluid as an average of the plurality of values of the antifreeze concentration.

40. The method of claim 38, further comprising:
calculating, in the processing unit, using the antifreeze concentrations determined using at least two of: the determined viscosity, the determined density, or the determined specific heat capacity, one or more differences in the thereby determined antifreeze concentrations; and
detecting, in the processing unit, a change in the fluid characteristics, in particular a change in the type of antifreeze in the fluid, if one of the one or more differences in the determined antifreeze concentrations exceed a defined difference threshold.

41. The method of claim 40, further comprising:
generating, in the processing unit, a notification message, upon detection of the change in the fluid characteristics.

42. The method of claim 40, further comprising:
storing, in the memory, one or more further sets of defined relations, each of the further sets of defined relations associated with a further type of fluid, in particular a further type of fluid having a different type of antifreeze;
selecting, in the processing unit, upon detecting the change in the fluid characteristics, a particular further set of defined relations associated with the changed type of fluid; and
determining the antifreeze concentration in the fluid using the particular further set of defined relations.

43. The method of claim 40, further comprising:
receiving, in the processing unit, from a remote server, a new or updated relation upon detecting the change in the fluid characteristics.

44. The method of claim 38, further comprising:
determining, in the processing unit, a freezing point of the fluid, using one or more of: the antifreeze concentration and a defined relation between antifreeze concentration and freezing point, or the measured speed of sound, the measured temperature and a defined relation between speed of sound, temperature, and freezing point in the fluid.

45. A device for determining the flow of a fluid in a channel, comprising a processing unit configured to perform the method according to claim 28.

46. The device of claim 45, further comprising a sensor system connected to the processing unit and configured to:
measure a flow velocity of the fluid, a speed of sound in the fluid, and a temperature of the fluid; and
transmit measurement data to the processing unit, the measurement data including the flow velocity of the fluid, the speed of sound in the fluid, and the temperature of the fluid.

47. The device of claim 45, further comprising a sensor system including an ultrasonic measurement assembly, the measurement assembly including two ultrasonic transducers coupled to the channel and wherein the ultrasonic measurement assembly is configured to:
measure transit times of surface acoustic waves between the ultrasonic transducers;
determine one or more of the following properties of the fluid using the transit times: a flow velocity, a speed of sound, a temperature, or an acoustic impedance; and
transmit measurement data to the processing unit, the measurement data including the one or more determined properties of the fluid.

48. A computer program product comprising computer program code configured to control a processing unit of a device such that the device performs the steps according to the method of claim 28.
